(19) United States
(12) Patent Application Publication
(10) Pub. No.: US 2026/0118867 A1
(43) Pub. Date: Apr. 30, 2026

(54) RECOMMENDATION OF AN ACTIONABLE ITEM

(71) Applicant: Honeywell International Inc., Charlotte, NC (US)

(72) Inventors: Sriram Hallihole, Byndoor (IN); Christopher Webb, Scottsdale, AZ (US); Peter Hart, KELLS MEATH (IE); Kiran Raviprakash, Bengaluru (IN); Rajeev Naduthota, Bangalore (IN)

(21) Appl. No.: 18/926,342

(22) Filed: Oct. 25, 2024

(51) Int. Cl. G05B 23/02

(52) U.S. Cl. CPC G05B 23/0275; G05B 23/0297

(57) ABSTRACT

Techniques for recommending actionable items are disclosed. Operations data, including conjoint variables and descriptors, is received from primary and secondary controllers, providing operational insights. A probable cause of potential operational lapse is determined based on these variables and descriptors. A parameter-assessment workflow is then determined, comprising logically interlinked assessments. These include a macro assessment, based on conjoint variables with primary limits and descriptors indicating the primary controller's status, and micro assessments, based on conjoint variables with secondary limits and descriptors indicating secondary controllers'status. Each micro assessment approaches the root cause more closely. An actionable item is identified based on the root cause, indicating an action to influence it. An action recommendation signal is then generated to render the actionable item, thereby enabling systematic analysis of operations data, identification of root causes for potential issues, and generation of targeted recommendations for corrective actions.

### BACKGROUND

An industrial process environment may include one or more processing facilities where finished products are produced through a series of processes or operations. In some cases, the processing facilities may be equipped with solutions to monitor and regulate various parameters associated with the operations for producing products as per requirements. Such solutions may utilize real-time data to anticipate future operation behaviours. However, there may be multiple scenarios where opportunities leading to lapse in the operations may arise and losses may be incurred.

### BRIEF DESCRIPTION OF DRAWINGS

The detailed description is described with reference to the accompanying figures. It should be noted that the description and figures are merely examples of the present subject matter and are not meant to represent the subject matter itself.

FIGS. 1A to 1D illustrate a block diagram of a computing environment 100 having a system, according to an example implementation of the present subject matter.

FIGS. 2A to 2C illustrate a block diagram of the set of hierarchically linked controllers in the computing environment, according to one example implementation of the present subject matter.

FIG. 3 illustrates a block diagram of a graphical user interface, according to one example implementation of the present subject matter.

FIG. 4 illustrates a block diagram of the system, according to one example implementation of the present subject matter.

FIG. 5 illustrates a block diagram of a computing environment comprising the system, according to another example implementation of the present subject matter.

FIG. 6 illustrates a block diagram of a hierarchical order of assessment, according to one example implementation of the present subject matter.

FIG. 7 illustrates a block diagram of an exemplary method for recommending an actionable item, according to one example implementation of the present subject matter.

FIG. 8 illustrates a non-transitory computer-readable recommending an actionable item, in accordance with an example of the present subject matter.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

With advancements in technology, various solutions have been developed for monitoring, controlling, and regulating parameters or variables associated with operations in processing facilities. For instance, specialized solutions and control systems may be utilized for monitoring, controlling, and/or regulating variables, for example, temperature, pressure, flow rates, and composition. Such solutions and control systems may help ensure product quality, safety, and overall performance of the operations. Further, regular maintenance of the solutions and control systems may be performed to support continuous operations.

In some aspects, optimizing the functioning of the processing facilities may also involve integrating advanced solutions to enhance efficiency and productivity. For example, the processing facilities may incorporate Advanced Process Control (APC) solutions and automation model predictive control (MPC) solutions that may utilize real-time data and predictive models to anticipate future operation behaviours and make adjustments in the variables as an attempt to improve stability, reduce variability, and potentially increase output.

However, there may be multiple scenarios where opportunities leading to lapse in the operations may arise and, thereby, losses may be incurred upon execution of the operations in the processing facilities. The variables associated with the operations, in one example, may be a reason for such lapse or loss. For instance, assignment of incorrect or inappropriate values to the variables may affect or hinder the operations in the processing facilities. Also, any unwanted or unauthorized modifications in the variables may lead to undesired behaviours in the operations.

Further, in some cases, the processing facilities may have a complex hierarchical architecture having multiple processing units. For example, the processing facilities may have Advanced Process Control (APC) units associated with individual operations of a processing facility. Each APC unit may perform individual processes for regulating or controlling the operation associated therewith. Such APC units may be, for example, controllers that regulate the operations in the processing facilities based on the variables. Generally, an APC limit may be defined for each of the variables associated with the operation. The APC limit may define a limit for the variables at the operation's level or APC's level and may be applicable specifically to that operation. Similarly, different APC limits may be defined for variables associated with different operations. In an industrial process environment, where there may be multiple operations, each variable may have a different APC limit for each operation.

Further, the processing facilities also have a plant-wide processing unit or plant-wide optimizer (PWO) for controlling and monitoring plant-wide operations. For example, the PWO may be a plant-wide controller to monitor and control the APC units associated with individual operations. The PWO may have a PWO limit for each of the variables. The PWO limit may define a plant-wide limit for each variable for different operations of the processing facility. Thus, a complex network of hierarchically connected controllers or processing units generally exists in an industrial processing environment, along with the corresponding limits.

Considering the complex architecture of the processing units in the processing facilities, tracking and identification of reasons or causes for benefits and losses or lost opportunities for the processing facility become complex, resource-extensive, and time-consuming process. The lost opportunities in the processing facilities may be due to several reasons, for example, power outages, shutdown or failure of any controller or other equipment, and incorrect settings of the variables that may lead to unacceptable or suboptimal output.

Also, in scenarios where there are operational lapses or losses are incurred, a user may be unaware of the reason or source of such lapse, especially considering the complex architecture within the industrial process environment. In such a complex system, it may be a complex and tedious process to analyze all the data and identify a root cause for any lapse in an operation. Even if the user identifies the root cause, it may be difficult for a user to decide a course of action that may be taken in such a complex interconnected architecture for resolving the lapse and minimizing losses being incurred due to flaws at one or more hierarchical levels.

Further, the operations of the processing facilities may get hampered due to reduced performance of the PWO and the APC units, which may happen due to several reasons, for example, constrained APC limits or non-optimal working of APC units associated with various operations in the processing facility. A thorough manual examination of operations data, including data from PWO and APC units, becomes necessary to identify the cause of such losses and minimize the lost opportunity of the processing facility. As a result, the downtime, or inefficient operation duration, of the processing facility or the operation may increase as resolving the reason for the lapse or issue may require a considerable amount of time, thereby increasing the incurred losses.

The present subject matter relates to techniques for recommending one or more actionable items for resolving the lapse. In one example, the one or more actionable items may include one or more actions that may be opted to resolve the lapse and reduce the losses being incurred.

According to one example, operations data may be received from a set of hierarchically linked controllers associated with an industrial process environment. The operations data may indicate one or more parameters related to an operation linked with the industrial process environment. The one or more parameters may include, in one example, a set of conjoint variables that may be common between the set of hierarchically linked controllers and, therefore interlinking one or more controllers in the set of hierarchically linked controllers. The set of conjoint variables may include, for example, critical variables. The critical variables may be, for example, variables linked with performance of the operation and having considerable importance for the operation.

Further, the set of hierarchically linked controllers may include a primary controller and one or more secondary controllers. The primary controller may be, for example, a plant-wide controller or PWO and the one or more secondary controllers or APC units may be associated with the operation. The one or more secondary controllers may be communicably linked with the primary controller via the conjoint variables. For example, the primary controller and the one or more secondary controllers may have same set of conjoint variables, however, the set of conjoint variables may have different limits for different controllers. For instance, the set of conjoint variables may have a plant-wide optimizer (PWO) limit or a plant-wide limit associated therewith, whereas the set of conjoint variables may have an Advanced Process Control (APC) limit or operation-level limit specifically for the operation with which the one or more secondary controllers are associated.

In another example, the one or more parameters may include one or more descriptors indicating one or more aspects related to at least one controller in the set of hierarchically linked controllers. For example, the one or more aspects may indicate an operational status of the primary controller and the one or more secondary controllers. The operational status may indicate, for example, whether any of the controllers were unavailable or whether any of the controllers were not operating in compliance with the PWO or APC limits.

In yet another example, the one or more parameters may include a message having at least one potential lapse indicator associated with the operation. The potential lapse indicator may be, for example, a text-based message that may indicate whether a potential lapse or any error occurred during the operation or whether an outcome of the operation was suboptimal or undesired. The potential lapse indicator may be defined or identified based on the set of conjoint variables and the one or more descriptors. For example, the potential lapse indicator may be a text message indicating whether any critical variable, in the set of conjoint variables, exceeded any of the defined PWO or APC limits. In another example, the potential lapse indicator may indicate whether any of the controllers associated with the operation was identified to be unavailable during the operation.

Thus, the operations data indicating at least one of the above parameters may be received from the set of hierarchically linked controllers. In one example, any combination of the above-discussed parameters could also be received from the set of hierarchically linked controllers.

Further, based on at least one of the set of conjoint variables, the one or more descriptors, and the message, a probable cause of potential lapse in the operation may be determined. For example, based on the set of conjoint variables, it may be determined whether any conjoint variable in the set of conjoint variables exceeded the APC limits. In one example, the conjoint variable may be any critical or important conjoint variable. If the critical conjoint variable is identified to have exceeded the limit, the critical conjoint variable may be determined as a probable cause of potential lapse. In another example, based on the content included in the message indicating occurrence of any error, say the occurrence of loss at PWO or primary controller, the message may indicate such an error. Based on the message, it may be determined that the PWO may be the probable cause of the potential lapse.

In one example, the highest contributor to the potential lapse may also be identified. For example, it may be determined which conjoint variable in the set of conjoint variables has the most significant contribution to the occurrence of the loss. In one example, the conjoint variable that may exceed the most beyond the APC limit may be determined as the highest contributor to the potential lapse. Such a conjoint variable may be determined as the probable cause of the potential lapse in the operation.

Once the probable cause has been determined, a parameter-assessment workflow, from amongst a plurality of parameter-assessment workflows, may be determined. In one example, there may be multiple pre-engineered parameter-assessment workflows for multiple scenarios or probable causes. For example, there may be a parameter-assessment workflow that may be performed when a critical conjoint variable is determined as the probable cause of the potential lapse. Similarly, there may be another pre-engineered parameter-assessment workflow to be performed when one of the secondary controllers becomes unavailable. Thus, there may be multiple such parameter-assessment workflows for different possible probable causes and one of the parameter-assessment workflows may accordingly be determined based on the determined probable cause for the potential lapse.

In one example, the parameter-assessment workflow may have a set of logically interlinked assessments for identifying a reason or root cause of the potential lapse. For example, the logically interlinked assessments may be checks that may first be performed at the primary controller and then drilled down towards the secondary controllers and, subsequently, towards the conjoint variables. In one example, the set of logically interlinked assessments or checks may include a macro assessment performed based on at least one of the set of conjoint variables having the PWO or primary limit associated therewith and the one or more descriptors indicating the operational status of the primary controller. For example, if loss at PWO was determined as the probable cause, the macro assessment may be performed to identify an error that may have probably occurred at the PWO or the primary controller. For example, the macro assessment may be performed to determine whether the primary controller was in an OFF state.

Based on the result of the macro assessment, a micro assessment or check may then be performed. The micro assessment may be a deeper check performed at a lower level than the macro assessment. For example, based on the result of the macro assessment, a micro assessment or check may be performed at APC or secondary controller's level. For instance, if it was determined, at the macro assessment that the primary controller was in the OFF state, the micro assessment may be performed to identify an underlying reason, or the root cause, for the primary controller being in the OFF state. In one example, one of the reasons for such an OFF state may be an OFF state of the secondary controller associated with the operation. For example, since the secondary controller may be critical for the primary controller to operate, the primary controller may have turned off because the secondary may have turned off. Thus, in this example, the micro assessment may be performed to determine whether the secondary controller, being critical for the operation of the primary controller, was in the OFF state.

Similarly, one or more micro assessments may be performed based on at least one of the set of conjoint variables, such as critical conjoint variables, having the secondary limit associated therewith and the descriptors indicating the operational status of the one or more secondary controllers. For example, subsequent to the micro assessment discussed in the above example, another micro assessment may be performed to determine whether any conjoint variable, such as any critical conjoint variable, dropped beyond the APC or the secondary limit. As discussed in the above example, the secondary controller may be critical for the primary controller to operate and the primary controller may have turned off because the secondary may have turned off. Similarly, the critical conjoint variable may be critical either for the functioning of the secondary controller or for the operation with which the secondary controller is associated. Non-compliance or non-availability of such critical conjoint variables may be one of the reasons that may have led to the turning off of the secondary controller, thereby being a possible root cause. For example, one of the reasons for such an OFF state of the secondary controller may be dependent on whether a critical conjoint variable complies with the APC or secondary limit. It may be possible, for instance, that the secondary controller may be in the OFF state because the critical conjoint variable may be beyond the APC limit. Therefore, in the subsequent micro assessment, it may be determined whether the critical conjoint variable complied with the APC limit. Since the conjoint variables may be correlated with input and output characteristics of the operation, they may be identified as the root cause for the potential lapse in the operation.

Thus, the micro assessment may be drilled down from the secondary controller's level to level of the conjoint variable to determine the root cause of the potential lapse in the operation. As each micro assessment may be a lower level check, as compared to its immediately preceding check, for example from the secondary controller's level to the conjoint variable's level, each of the one or more micro assessments may be increasingly proximate to the root cause for the potential lapse as compared to the immediately preceding micro assessment.

Further, based on the root cause of the potential lapse, an actionable item may be identified from amongst a plurality of actionable items. The actionable item may be an indication of one or more actions that a user may perform to influence the root cause leading to the potential lapse. For example, for different root causes, there may be a pre-defined actionable item. Based on the determined root cause, an actionable item corresponding to the root cause may be identified. For example, the actionable item may indicate that the value of a critical conjoint variable may be modified to comply with the APC or the secondary limit. As the state of the secondary controller may be dependent upon compliance of the critical conjoint variable, modification of the critical conjoint variable may result in changing the state of the secondary controller. Further, as the state of the primary controller may be dependent upon the state of the secondary controller, a change in the state of the secondary controller may cause a change in the state of the primary controller. Thus, the actionable item may indicate that the critical conjoint variable may be modified to resolve the potential lapse and, thereby, assist the user in resolving or at least influencing the root cause of the potential lapse. Once the actionable item has been identified, an action recommendation signal may be generated to cause rendering of the identified actionable item. Therefore, by recommending the actionable item, the user may be provided with an action that may be performed to influence or resolve the potential lapse.

Therefore, the present subject matter discloses systematic and hierarchical assessment techniques for determining the root cause of the potential lapse in industrial processes or environments having complex architectures, starting from a high-level primary controller, down to secondary controllers, and subsequently to individual conjoint variables associated with the operation or industrial process. The logically interlinked assessments that drill down from macro to micro levels, allow for increasingly precise identification of root causes for the potential lapse in the operation. Thus, such a multi-level assessment may help in accurately determining the level at which an error, or root cause of the lapse, exists in such complex industrial environments.

Precise determination of the root cause may further enable in identification of an appropriate actionable item to resolve, or at least influence, the root cause leading to the potential lapse. Therefore, the present subject matter, in addition to identification of the root cause affecting the operation, also identifies and recommends suitable actions based on the identified root cause to resolve the potential lapse, thereby providing concrete steps to influence or resolve the potential lapse.

Further, generation of the action recommendation signal may cause the rendering of the identified actionable item, thereby ensuring that the recommended actions are promptly rendered. A user may thus be able to correctly and quickly take necessary or required actions for reducing or minimizing the lapse or loss being incurred by the operation. The lapses may thus be resolved in a fast and efficient manner, thereby enhancing overall efficiency, minimizing downtime, and avoiding disruption in the operation. Therefore, the present subject matter discloses techniques that allow for a systematic and automated approach to identifying and resolving operational issues in complex industrial environments, potentially improving efficiency and reducing losses.

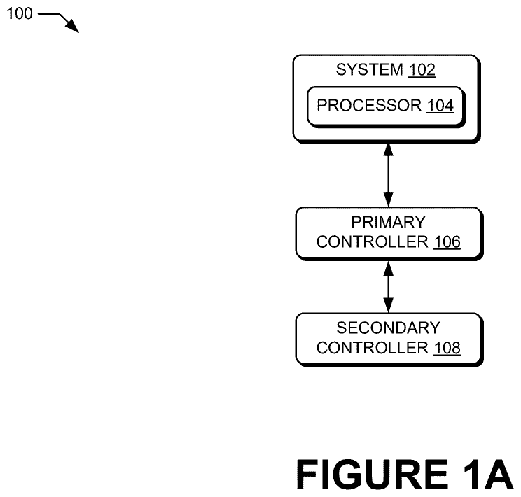

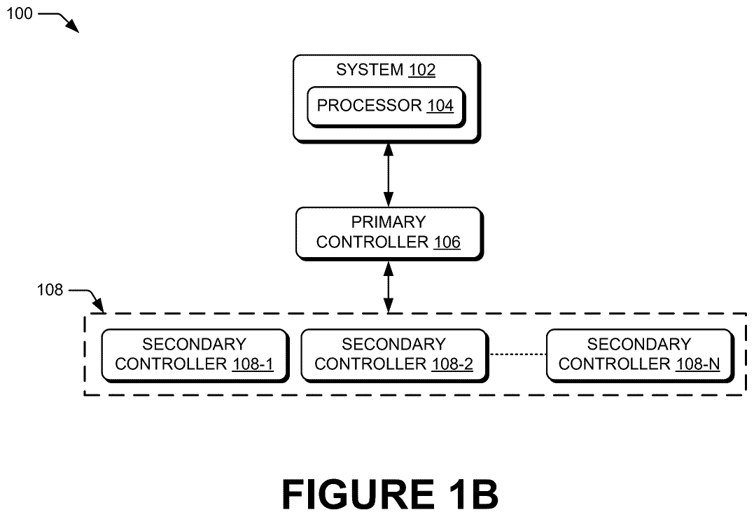

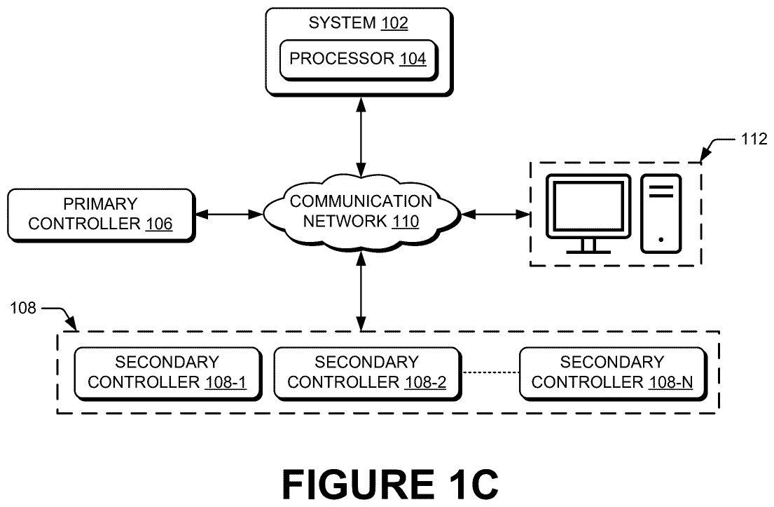

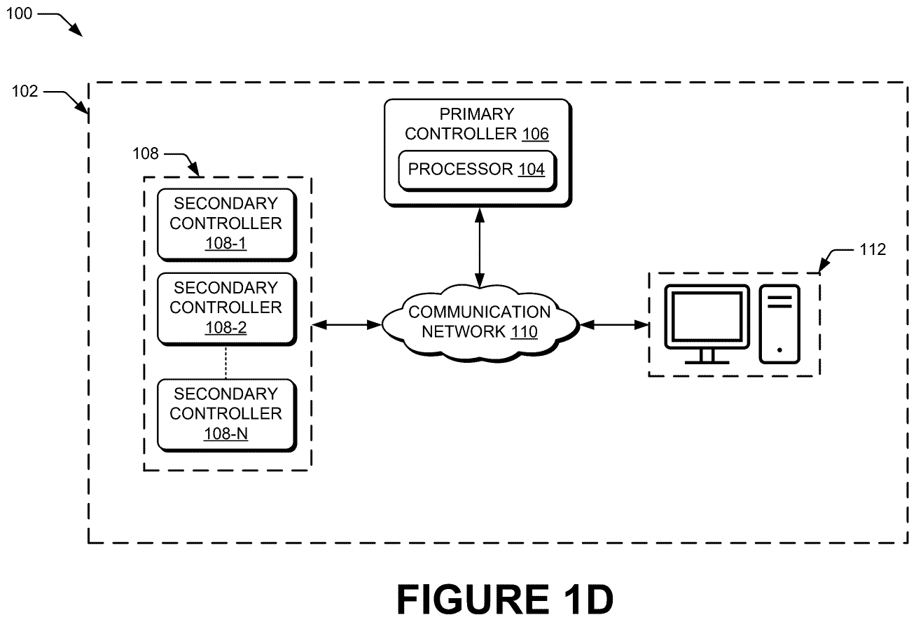

The above techniques are further described with reference to FIGS. 1A to 8. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIGS. 1A to 1D illustrate a block diagram of a computing environment 100 having a system 102, according to an example implementation of the present subject matter. FIGS. 1A to 1D may be discussed in conjunction with each other.

The computing environment 100 may be any computing environment comprising the system 102. In one example, the computing environment 100 may be an industrial process environment having one or more processing facilities associated therewith. In one example, the processing facilities may be units where raw materials may be processed into finished products through a series of chemical, physical, mechanical, or biological operations. Examples of the processing facilities may include, but are not limited to, manufacturing units, assembling units, testing units, and material processing units or plants. Further, the processing facilities could also be units related to different sectors. For example, the processing facilities may be related to data management, data processing, platform development and/or management, software development and/or management, petrochemicals, pharmaceuticals, food and beverage, water treatment, chemical processing, metallurgical engineering, communication network, content delivery network, and automobile sector. The processing facilities may also be related to, for example, aircraft-related services, finance-related services, e-commerce-related services, cloud-based services, content delivery networks, and an organization. Other examples of the processing facilities may also be possible.

Further, the system 102 may be configured, in one example, for recommending one or more actionable items for resolving one or more potential lapses. In one example, the potential lapses may be associated with one or more operations executed, or being executed, in a processing facility. The one or more actionable items may have, in one example, one or more actions that may be recommended to resolve the potential lapse and reduce the losses being incurred, as will be discussed.

In one example, the system 102 may be implemented in the computing environment 100 as a set of one or more hardware devices or modules for monitoring and/or processing operations data generated by components of the computing environment 100, as exemplarily illustrated in FIGS. 1A to 1C and discussed below, to identify and recommend the one or more actionable items for at least influencing the potential lapse. For example, the system 102 may be implemented as a set of one or more hardware devices, comprising at least a processor 104. The processor 104 may be implemented as a dedicated processor, a shared processor, or a plurality of individual processors, some of which may be shared. Examples of the processor 104 may include, but are not limited to, microprocessors, microcomputers, microcontrollers, digital signal processors, central processing units, state machines, Artificial Intelligence (AI) based processors, machine learning-based processors, deep learning-based processors, system on chip (SOC), processing circuitries including one or more modules or engines, and/or any other devices that manipulate signals and data based on computer-readable instructions, and/or any other devices.

In another example, the system 102 may be implemented as a set of computer-executable instructions for recommending one or more actionable items. In this example, the processor 104 may be an engine capable of executing the set of computer-executable instructions that may monitor and/or process the operations data to identify and recommend one or more actionable items. Examples of the system 102, according to this example, may include, but are not limited to, software applications, cloud-based platforms, and Software as a Service (SaaS). In yet another example, the system 102 may be implemented as a combination of the one or more hardware devices and the set of computer-executable instructions. In this example, the set of computer executable instructions may be executed by the processor 104 to identify and recommend the one or more suitable actionable items for at least influencing the potential lapse.

Further, the computing environment 100 may include a set of controllers. For example, in the industrial process environment, there may be multiple controllers that may be communicably coupled with each other. In one example, the set of controllers may include a primary controller 106 and a secondary controller 108, as illustrated in FIG. 1A. Each of the primary controller 106 and the secondary controller 108 may be implemented as a dedicated controller, a shared processor, or a plurality of individual controllers, some of which may be shared. Examples of each of the primary controller 106 and the secondary controller 108 may include, but are not limited to, microprocessors, microcomputers, microcontrollers, digital signal processors, central processing units, state machines, Artificial Intelligence (AI) based processors, machine learning-based processors, deep learning-based processors, system on chip (SOC), processing circuitries including one or more modules or engines, and/or any other devices that manipulate signals and data based on computer-readable instructions, and/or any other devices.

In another example, the set of controllers may include the primary controller 106 which may be communicably coupled with a plurality of secondary controllers, as illustrated in FIG. 1B. For example, the primary controller 106 may be in direct communication with a secondary controller 108-1, secondary controller 108-2, . . . , and secondary controller 108-N, where N is a natural number, as illustrated in FIG. 1B. The secondary controller 108-1, secondary controller 108-2, . . . , and secondary controller 108-N may hereinafter be referred to as one or more secondary controllers 108.

In one example, the primary controller 106 may be in direct communication with the secondary controller 108 and the system 102 or at least the processor 104, as illustrated in FIG. 1A, to exchange data and/or signals. In another example, the primary controller 106 may be in direct communication with the one or more secondary controllers 108 and the system 102 or at least the processor 104, as illustrated in FIG. 1B, to exchange data and/or signals. In yet another example, the primary controller 106, the one or more secondary controllers 108, and the system 102 or at least the processor 104 may be communicably coupled via a communication network 110, as illustrated in FIG. 1C, to exchange data and/or signals. For example, the primary controller 106, the one or more secondary controllers 108, and the system 102 or at least the processor 104 may be distanced from each other and thus communicably coupled to exchange data and/or signals via the communication network 110. In one example, the primary controller 106 may also be configured to control the operation and functioning of the one or more secondary controllers 108.

Examples of the communication network 110 may include, but are not limited to LAN, WAN, the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 110 may include various network entities, such as transceivers, gateways, and routers. In an example, the communication network 110 may include any communication network that uses any of the commonly used protocols, for example, Hypertext Transfer Protocol (HTTP), and Transmission Control Protocol/Internet Protocol (TCP/IP).

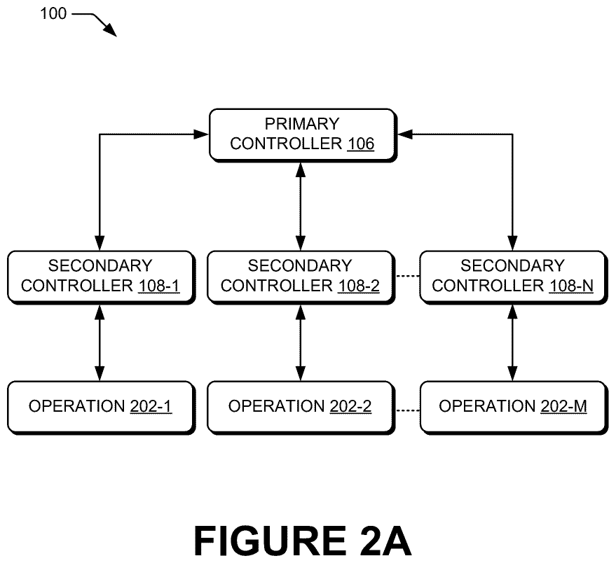

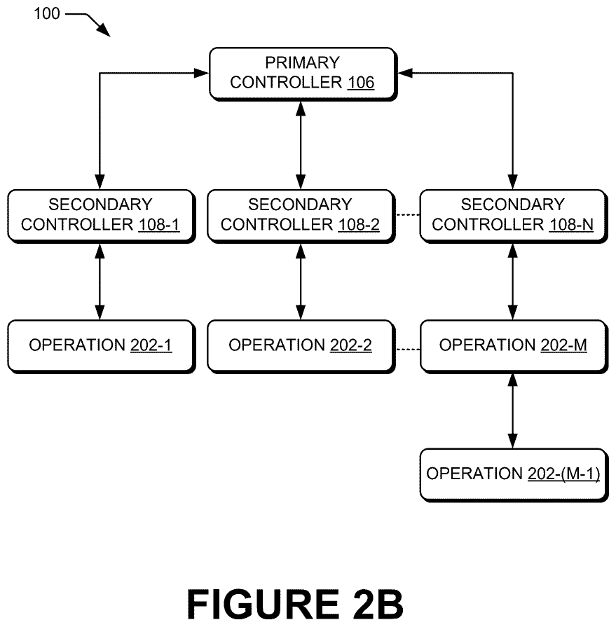

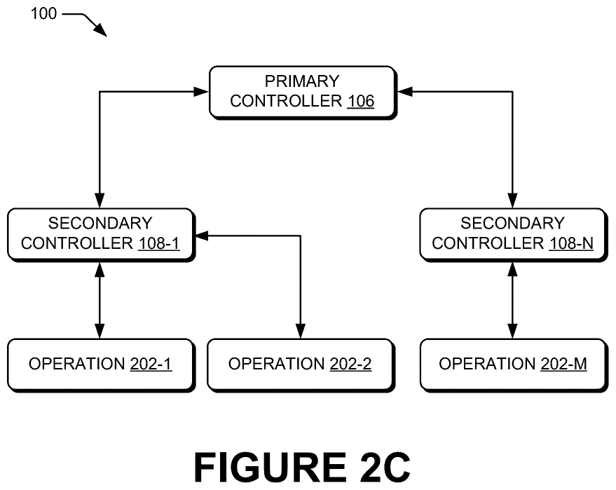

Further, in one example, the set of controllers may be a set of hierarchically linked controllers. For example, the primary controller 106 and the one or more secondary controllers 108 may be hierarchically linked controllers. FIGS. 2A to 2C illustrate a block diagram of the set of hierarchically linked controllers in the computing environment 100, according to one example implementation of the present subject matter. FIGS. 2A to 2C will be discussed in conjunction with FIGS. 1A to 1D. In one example, the primary controller 106 may be a processing facility-wide processing unit or plant-wide optimizer (PWO) for controlling and monitoring plant-wide operations. For example, the primary controller 106 may control working of one or more operations linked with the industrial process environment, say the computing environment 100. Further, each of the one or more secondary controllers 108 may be dedicatedly configured to monitor and/or control an operation being implemented in the processing facility. For example, each of the one or more secondary controllers 108 may be individually associated with an operation from amongst a plurality of operations linked with the industrial process environment.

As each of the one or more secondary controllers 108 may be communicably coupled or interlinked with the primary controller 106, and where the primary controller 106 may be the plant-wide controller and the one or more secondary controllers 108 may be associated with individual operations, the primary controller 106 may thus be considered as a higher level controller in the industrial process environment as compared to the one or more secondary controllers 108. Thus, there may be a hierarchical relationship between the primary controller 106 and the one or more secondary controllers 108. Therefore, the primary controller 106 and the one or more secondary controllers 108 may be referred to as the set of hierarchically linked controllers. Similarly, there may be other basis on which a hierarchical relationship may derived between the primary controller 106 and the one or more secondary controllers 108. Thus, the communicably coupled controllers, in an industrial process environment, may be referred to as the set of hierarchically linked controllers.

Further, as discussed above, each of the one or more secondary controllers 108 may be associated with an operation being implemented in the processing facility. For example, the secondary controller 108-1 may be associated with an operation 202-1, the secondary controller 108-2 may be associated with an operation 202-2, and the secondary controller 108-N may be associated with an operation 202-M, where M is a natural number, as illustrated in FIG. 2A. The operations 202-1, 202-2, . . . , and 202-M may hereinafter individually be referred to as operation 202 and collectively be referred to as operations 202. Examples of the operation 202 may include, but are not limited to, a physical, chemical, biological, mechanical, development, or testing operation that may be implemented within any processing facility. Thus, each of the one or more secondary controllers 108 may be dedicatedly associated with an operation. The one or more secondary controllers 108 may also be referred to as Advanced Process Control (APC) units. However, other implementations may also be possible. For example, it may also be possible that a secondary controller may be associated with more than one operation. For instance, the secondary controller 108-N may be associated with two interlinked operations, say operations 202-M and 202-(M-1), as illustrated in FIG. 2B. In yet another example, it may be possible that a secondary controller may be associated with more than one operation. For example, the secondary controller 108-1 may be associated with the operation 202-1 and 202-2, as illustrated in FIG. 2C.

In one example, each of the operations 202 may have associated therewith a set of conjoint variables. Each set of conjoint variables may be correlated with the input characteristics and output characteristics of an operation. For example, each of the operations 202 may have a set of conjoint variables associated therewith and indicating input and output characteristics of a corresponding operation. For example, the set of conjoint variables may include a variable indicating a flow rate with which a fluid was supplied for performing an operation and another variable indicating a flow rate with which a processed fluid was outputted due to the performance of the operation. Similarly, the set of conjoint variables may also include other variables, indicating different input and output characteristics of an operation. Examples of the input and output characteristics may include, but are not limited to, bit rate, temperature, volume, weight, quality, quantity, and other measurable characteristics. In one example, values of such characteristics may be indicated using the conjoint variables. In one example, the one or more secondary controllers 108 may monitor the performance of each of the operations 202 and determine values for each variable in the set of conjoint variables based on the input and output characteristics of each of the operations.

In another example, the set of conjoint variables may include one or more conjoint variables based on which input characteristics of the operations 202 may be manipulated or controlled, thereby controlling or influencing the output of the operations 202 and, thereby the output characteristics of the operations 202. For example, input being provided for an operation may be controlled or regulated by the one or more secondary controllers 108 based on the set of conjoint variables. For example, the set of conjoint variables may include a conjoint variable indicating a flow rate of a fluid to be maintained or supplied for performing an operation, and another conjoint variable indicating an output flow rate of a processed fluid that may be expected due to performance of the operation. As the input may influence, or have some relation with, the output, the output characteristics may be dependent on the input characteristics.

Thus, each set of conjoint variables, in one example, may be correlated with the input and output characteristics of a corresponding operation from amongst the operations 202. The conjoint variables correlated with the input characteristics of an operation may be referred to as manipulative variables (MVs) and may be modifiable or adjustable variables. The set of conjoint variables may include, in one example, one or more MVs. Examples of the MVs may include, but are not limited to, temperature, pressure, volume, flow rate, current, resistance, and size of data. Further, the conjoint variables correlated with the output characteristics of an operation may be referred to as control variables (CVs). The set of conjoint variables may include, in one example, one or more CVs. For example, CVs may indicate an amount, quality, and/or quantity of the output generated by the performance of an operation. Other examples of CVs indicating output characteristics related to an operation or process may also be possible.

Thus, each of the operations 202 may have a set of conjoint variables associated therewith and correlated with input and output characteristics associated with the corresponding operation. Further, adjustment of the MVs may cause modification of the CVs. For example, as the conjoint variables correlated with the input characteristics, i.e., MVs, of an operation may be modified, the output obtained or generated due to the performance of the operation, and thus the CV associated with the output characteristics, may accordingly be modified.

Further, the set of conjoint variables may also include, in one example, one or more critical conjoint variables. The critical conjoint variables may be one or more variables, for example, that may be of high or critical importance. For example, temperature may be a critical conjoint variable associated with input being provided to an operation related to the melting of metal. In one example, the critical conjoint variables may be one or more variables from amongst the CVs and MVs associated with each of the operations 202. However, it may also be possible, in another example, that the critical conjoint variables may be one or more variables that may be different from the CVs and MVs, but may be correlated or associated with input and/or output characteristics of the corresponding operation.

Further, one or more controllers, from amongst the set of hierarchically linked controllers, may be interlinked using the set of conjoint variables. For example, the primary controller 106 may be connected to the one or more secondary controllers 108 via the set of conjoint variables. In one example, the one or more secondary controllers 108, associated with corresponding operations, may store the set of conjoint variables associated with the corresponding operations. The primary controller 106, being a plant-wide controller, may also store the set of conjoint variables associated with each of the operations 202. Thus, the primary controller 106 may have at least the set of conjoint variables available with the one or more secondary controllers 108. In another example, the one or more secondary controllers 108 may send the set of conjoint variables available with them to the primary controller 106. The set of conjoint variables may thus be a common link between the primary controller 106 and the one or more secondary controllers 108, thereby forming an interlinking and hierarchical relationship between the primary controller 106 and the one or more secondary controllers 108.

However, in one example, the set of conjoint variables may have different limits for different controllers. For example, the primary controller 106 may have a plant-wide optimizer (PWO) limit, whereas the one or more secondary controllers 108 may have an Advanced Process CSontrol (APC) limit for the set of conjoint variables. In one example, the PWO limit may define a plant-wide limit for each variable in the set of conjoint variables. Whereas, the APC limit may define a limit for each variable, in the set of conjoint variables, at the operation's level or secondary controller's level and may apply specifically to the operation with which the set of conjoint variables are associated. For example, the conjoint variable indicating temperature may have the PWO or primary limit associated therewith, whereas the same variable may have another limit, i.e., the APC or secondary limit specific to the operation with which the conjoint variable (indicating temperature) is associated. Similarly, different APC limits may be defined for different conjoint variables, in the set of conjoint variables, for each of the operations 202.

In one example, the PWO limit and the APC limit may be defined by a user. The user may be, for example, an operator associated with the industrial process environment. In one example, the user may define the PWO limit and the APC limit using a workstation 112, as illustrated in FIGS. 1C and 1D. The workstation 112 of the computing environment 100 may be communicably coupled with the primary controller 106, the one or more secondary controllers 108, and the system 102 or at least the processor 104. In one example, the workstation 112 may include a display device and an input mechanism that may enable a user to configure the PWO and the APC limits. The input mechanism may be, for example, a keyboard, mouse, or even a touch input received on the display device of the workstation 112. In one example, the display device may render a graphical user interface that may enable the user to configure the PWO and the APC limits. Further, the PWO limit and the APC limit may hereinafter interchangeably be referred to as primary limit and secondary limit, respectively.

In one example, violation or non-compliance of any of the primary and/or the secondary limits by any of the variables, in the set of conjoint variables, may lead to a potential lapse. For example, if a conjoint variable in the set of conjoint variables violates or does not comply with the secondary limit defined for that conjoint variable, the operation with which such conjoint variable may be associated may experience a potential lapse. In another example, violation or non-compliance of any of the primary and/or the secondary limits by any critical conjoint variable, in the set of conjoint variables, may lead to the potential lapse. In one example, the potential lapse may be any hindrance or restriction that may limit the performance or output of the operation, thereby affecting its efficiency and leading to losses or lost opportunities. In another example, the potential lapse may also be undesired or unwanted input and/or output characteristics of the operation. Thus, the potential lapse, for example, may be related to loss, or lost opportunity leadin to a probable loss, incurred by the operation linked with the industrial process environment.

Further, the one or more secondary controllers 108 may be configured to share data indicating values of the set of conjoint variables, associated with each of the operations 202, with the primary controller 106. The data may be shared by the one or more secondary controllers 108 either regularly or at predefined intervals. In another example, the operations data may also be shared by the one or more secondary controllers 108 upon completion of one or more operations from amongst the operations 202. Further, in one example, it may also be possible that the primary controller 106, based on the data received from the one or more secondary controllers 108, may generate data indicating values of the set of conjoint variables stored with the primary controller 106.

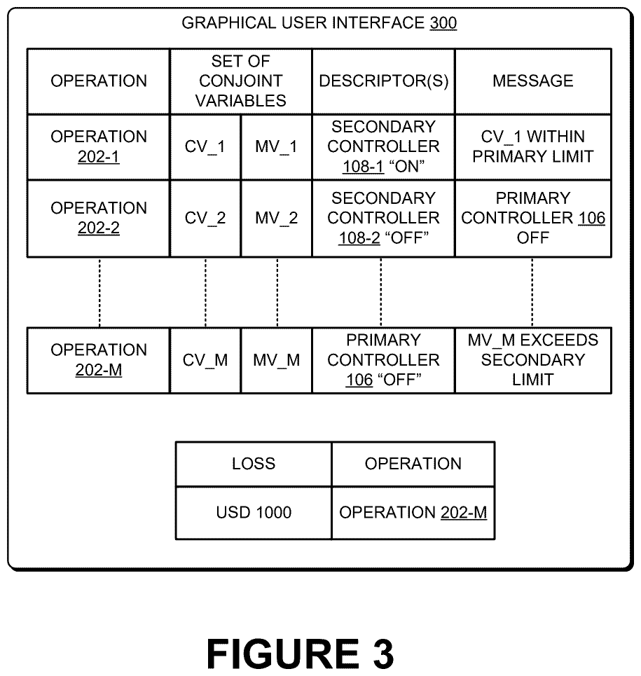

Further, the set of hierarchically linked controllers may generate, in one example, one or more descriptors indicating one or more aspects related to one or more controllers in the set of hierarchically linked controllers. For example, the one or more secondary controllers 108 may generate data or descriptors indicating one or more aspects about them. In one example, the primary controller 106 may also generate data or descriptors indicating one or more aspects about it. The one or more aspects may indicate, for example, an operational status indicating whether the primary controller 106 and/or any of the secondary controllers associated with the one or more operations were unavailable or were not operating in compliance with the primary and/or secondary limits. The operational status may indicate, for example, “PRIMARY CONTROLLER 106 “OFF”” (as indicated in FIG. 3) to indicate that the primary controller 106 was unavailable for, or during performance of, the operation 202-M. Further, the operational status may indicate, for example, “PRIMARY CONTROLLER 106 “ON”” to indicate that the primary controller 106 was available. Similarly, one or more aspects about the one or more secondary controllers 108 associated with the one or more operations may also be indicated. Other examples of aspects may also be possible.

In one example, the set of hierarchically linked controllers may also be configured to generate a message. In one example, the message may indicate whether the operation was performed, or is being performed, as per desired requirements. For example, the message may indicate whether the controllers are available and/or operational as desired and whether the conjoint variables in the set of conjoint variables comply with the primary and/or secondary limits. In one example, the message may include at least one potential lapse indicator associated with the operation. The potential lapse indicator may be, for example, a textual indicator identifying the potential lapse or an error that may have occurred during the operation. For example, the potential lapse indicator may indicate a description about the potential lapse or an error in the performance of the operation, or in the input and/or output characteristics associated with the operation. For example, if any critical conjoint variable, say MV_M, may have exceeded the primary and/or secondary limits, a potential lapse indicator may be indicated that may represent details about such incidence. For example, as illustrated in FIG. 3, the message may indicate that MV_M exceeds the secondary limit defined for the operation 202-M. Similarly, a potential lapse indicator may be indicated to indicate the operational status of a controller. For example, the potential lapse indicator may indicate whether any of the controllers associated with the operation was identified to be unavailable during the operation. As illustrated in FIG. 3, as an example for operation 202-2, the message may indicate that the primary controller 106 may be OFF. Thus, the potential lapse indicator may identify the at least one potential lapse based on the set of conjoint variables and the one or more descriptors.

Further, in one example, the computing environment 100 may include the workstation 112. As discussed above, the workstation 112 may be used by a user for configuring the primary and the secondary limits. For example, the workstation 112 may be used for defining the primary and/or the secondary limits. The workstation 112 may also be used for multiple other purposes. For example, the workstation 112 may be used for configuring the set of hierarchically linked controllers and/or the processor 104. The workstation 112 may also be used to logically add or remove one or more controllers from the computing environment 100.

Further, in one example, the workstation 112 may render a graphical user interface that may indicate different information about the industrial process environment, such as the computing environment 100, and the components therein. FIG. 3 illustrates a block diagram of such a graphical user interface 300, according to one example implementation of the present subject matter. FIG. 3 has been discussed in conjunction with FIGS. 1A to 2C.

The graphical user interface 300 may be rendered, in one example, on the display device associated with the workstation 112. The graphical user interface 300 may be, for example, an interactive interface with which the user may be able to interact and view different information related to the industrial process environment and/or the components therein. For example, the user may be able to view, interact, modify, and customize the information being rendered via display device and the input mechanism associated with the workstation 112. In one example, the graphical user interface 300 may be a dashboard that may be rendered on the display device.

In one example, the graphical user interface 300 may indicate details of one or more operations associated with the industrial process environment, such as the operation 202-1, . . . , operation 202-M. The graphical user interface 300 may also indicate the set of conjoint variables, or values thereof. For example, the column “SET OF CONJOINT VARIABLES” may indicate one or more conjoint variables, or values thereof, associated with the operations 202. As exemplarily illustrated, CV_1 and MV_1, or values thereof, may be indicated for operation 202-1. Similarly, CV_M and MV_M, or values thereof, may be indicated for operation 202-M. Further, in one example, more than one CV and MV could also be associated with an operation, though not illustrated in the graphical user interface 300.

The graphical user interface 300 may also indicate, in one example, the one or more descriptors indicating one or more aspects related to at least one controller in the set of hierarchically linked controllers, such as the operational status of the one or more secondary controllers 108 associated with the operation and/or operational status of the plat-wide controller or the primary controller 106, as illustrated and discussed above.

The graphical user interface 300 may also indicate, in one example, the message indicating whether the operation was performed, or is being performed, as per desired requirements. As exemplarily illustrated for operation 202-1, the message may indicate that the CV_1 is within the primary limit if the CV_1 is determined to be within the primary limit. In one example, such a determination may be made by the primary controller 106 as the primary limit may be associated with the primary controller 106. Further, as exemplarily illustrated for another operation 202-M, the message may indicate that the MV_M may be exceeding the secondary limit. In one example, such a determination may be made by a secondary controller associated with the operation 202-M, as the secondary limit may be associated with that secondary controller. In another example, such a determination could also be made by the primary controller 106. Similarly, different conjoint variables, descriptors, and messages may be indicated via the graphical user interface 300 for one or more operations associated with the industrial process environment.

Further, the graphical user interface 300 may also indicate, in one example, the loss incurred for the one or more operations associated with the industrial process environment. In one example, the loss may be indicated as an amount lost due to performance of the operation based on the corresponding conjoint variables. As exemplarily illustrated, a loss of USD 1000 may probably have been incurred by the operation 202-M. Similarly, other details and information related to different operations may also be rendered or indicated via the graphical user interface 300.

Thus, the computing environment 100 illustrates an example of an industrial process environment that may, in one example, have a plant-wide controller, such as the primary controller 106, and one or more process control units, such as the one or more secondary controllers 108, linked with one or more processes associated with the industrial process environment. In one example, the system 102, or at least the processor 104, may be communicably coupled with such plant-wide controllers and/or process control units to recommend one or more actionable items that may be opted for resolving the lapse and losses being incurred in the industrial process environment. FIGS. 1A to 1C illustrate that the system 102 may be communicably coupled with the primary controller 106 and the one or more secondary controllers 108. However, other implementations may also be possible. For example, the system 102 may include the primary controller 106 and the one or more secondary controllers 108, and the processor 104 may be a part of the primary controller 106, as illustrated in FIG. 1D. Also, in one example, the processor 104 may be the primary controller 106 itself or a processor of the primary controller 106. Similarly, different architectures may also be possible, though not illustrated.

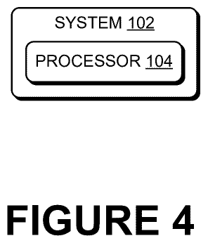

FIG. 4 illustrates a block diagram of the system 102, according to one example implementation of the present subject matter. FIG. 4 will be discussed in conjunction with FIGS. 1A to 3 for the sake of brevity. In one example, the system 102 may recommend an action for resolving a lapse. The system 102 may include the processor 104 that may identify an actionable item indicating the action that may probably resolve the lapse in an operation associated with an industrial process environment.

In one example operation, the processor 104 may receive operations data from a set of hierarchically linked controllers associated with an industrial process environment. The operations data may provide an insight about one or more parameters related to an operation linked with the industrial process environment. The one or more parameters may include, in one example, at least one of the set of conjoint variables and the one or more descriptors. The set of conjoint variables, in one example, may be correlated with input characteristics and output characteristics of the operation. The set of conjoint variables may also interlink two or more controllers from amongst the set of hierarchically linked controllers. For example, the set of conjoint variables may be common between the primary controller 106 and the one or more secondary controllers 108.

Further, the set of hierarchically linked controllers may include the primary controller 106 having the primary limit associated with the set of conjoint variables. In one example, the primary limit may be the plant-wide limit for the set of conjoint variables. The set of hierarchically linked controllers may include the one or more secondary controllers having the secondary limit associated with the set of conjoint variables. In one example, the secondary limit may be the operation-level limit for the set of conjoint variables. Further, the one or more descriptors may indicate one or more aspects related to at least one controller in the set of hierarchically linked controllers. The one or more aspects may include, for example, the operational status of the primary controller 106 and the one or more secondary controllers 108.

Based on at least one of the set of conjoint variables and the one or more descriptors, the processor 104 may determine a probable cause of a potential lapse in the operation. For example, based on the set of conjoint variables, the processor 104 may determine whether any conjoint variable in the set of conjoint variables exceeded the primary and/or secondary limits. If a conjoint variable is identified to have exceeded the primary and/or secondary limits, the conjoint variable may be determined as a probable cause of potential lapse in the operation.

Further, the processor 104 may determine a parameter-assessment workflow, from amongst a plurality of parameter-assessment workflows. The determination may be based on the determined probable cause. In one example, the parameter-assessment workflow may include a set of logically interlinked assessments that may include a macro assessment and one or more micro assessments.

In one example, the processor 104 may perform the macro assessment based on at least one of the set of conjoint variables having the primary limit associated therewith and the one or more descriptors indicating the operational status of the primary controller 106. Further, the processor 104 may perform the one or more micro assessments based on at least one of the set of conjoint variables having the secondary limit associated therewith and the one or more descriptors indicating the operational status of the one or more secondary controllers 108.

The processor 104 may perform the one or more micro assessments based on a result of at least one of the macro assessment and an immediately preceding micro assessment. Further, each micro assessment may be increasingly proximate to a root cause for the potential lapse as compared to the immediately preceding micro assessment. Further, the processor 104 may perform the one or more micro assessments until the root cause is identified.

Further, the processor 104 may identify an actionable item, from amongst a plurality of actionable items, based on the root cause. In one example, the actionable item may be identified for indicating an action intended to at least influence the root cause leading to the potential lapse. The processor 104 may then generate an action recommendation signal to cause rendering of the identified actionable item.

Thus, the present subject matter provides techniques that may assist a user in identifying a root cause leading to the potential lapse and recommending a suitable action to at least influence the root cause and, thereby attempt to minimize the potential lapse. Therefore, the user may be able to correctly and quickly take required actions for reducing or minimizing the lapse or loss being incurred by the operation. Further, the lapses may be resolved in a fast and efficient manner, thereby enhancing overall efficiency, minimizing downtime, and avoiding disruption in the operation.

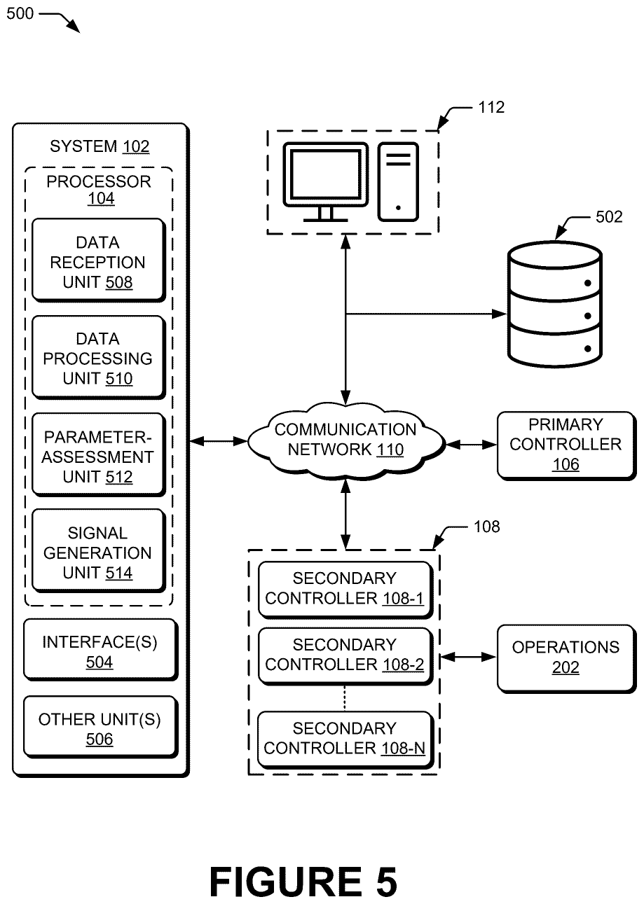

FIG. 5 illustrates a block diagram of a computing environment 500 comprising the system 102, according to another example implementation of the present subject matter. FIG. 5 will be discussed in conjunction with FIGS. 1A to 3 for the sake of brevity. The subject matter disclosed in the description of FIGS. 1A to 3 will be incorporated herein as reference for the sake of brevity.

In one example, the computing environment 500 may be similar to the computing environment 100 discussed with reference to FIGS. 1A to 2C. The computing environment 500, similar to the computing environment 100, may include the system 102 and the set of hierarchically linked controllers, for example, the primary controller 106 and the one or more secondary controller 108. The computing environment 500 may also include, in one example, the workstation 112 and a datastore 502.

In one example, the datastore 502 may include a set of storage devices capable of storing data, signals, and/or information. The set of storage devices may be virtual storage devices, physical storage devices, a cloud-based storage service, or a combination thereof. For example, the datastore 502 may be any repository or storage unit implemented by physical, logical, and/or virtual storage devices. In one example, the datastore 502 may include a set of physical storage devices. In another example, the datastore 502 may include virtual storage devices being implemented on physical storage devices. In another example, the datastore 502 may include one or more physical or logical storage units that may either be located at the same location or distributed geographically. In another example, the datastore 502 may be implemented over a cloud-based storage service. Further, the system 102, the set of hierarchically linked controllers, the workstation 112, and the datastore 502 may be communicably coupled via the communication network 110 to exchange data and/or signals. The computing environment 500 may thus be a network of such entities that may be communicably coupled with each other, for example, over the communication network 110.

As discussed above, the computing environment 500 may include the system 102 configured for recommending one or more actions for resolving the lapse in an operation associated with the industrial process environment. In one example, the system 102 may include the processor 104 for determining the root cause and accordingly recommending the one or more actions for resolving, or at least influencing, the root cause leading to the potential lapse in the operation associated with the industrial process environment. In one example, the potential lapse in the operation may be related to a loss or lost opportunity indicating a probable loss incurred by the operation linked with the industrial process environment. The lost opportunity, for example, may be a condition, event, or scenario that may lead to the probable loss. The loss may be, for example, financial or economic loss incurred by the operation. In another example, the loss may be a loss of operational efficiency, quality, or quantity.

Further, in addition to the examples discussed above in FIGS. 1A to 2C, other examples of the industrial process environment may include, but are not limited to, manufacturing plants, chemical processing plants, food processing facilities, steel mills, paper mills, textile mills, petrochemical plants, glass manufacturing plants, mining operations, power generation plants, semiconductor manufacturing labs, and biotechnology labs.

Further, the processor 104 may be implemented as a dedicated processor, a shared processor, or a plurality of individual processors, some of which may be shared. Examples of the processor 104 may include, but are not limited to, microprocessors, microcomputers, microcontrollers, digital signal processors, central processing units, state machines, Artificial Intelligence (AI) based processors, machine learning-based processors, deep learning-based processors, system on chip (SOC), processing circuitries including one or more modules or engines, and/or any other devices that manipulate signals and data based on computer-readable instructions, and/or any other devices.

The system 102 may further include, in one example, interface(s) 504 that may allow communicably coupling the system 102, and/or the processor 104, with one or more other entities, such as the communication network 110, the set of hierarchically linked controllers, the datastore 502, and the workstation 112. The connection or coupling may be through a wired connection or a wireless connection.

In one example, the system 102 may further include other unit(s) 506. The other unit(s) 506 may include, in one example, a power supply unit and a communication unit. The power supply unit may, for example, manage distribution or supply of electrical current within the system 102 for functioning of the system 102. Further, the communication unit may be, in one example, a wireless communication unit. Examples of the communication unit may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication unit may also include one or more antennas to enable wireless transmission and reception of data and signals. The communication unit may allow the system 102 to be communicably coupled with the communication network 110, the set of hierarchically linked controllers, the datastore 502, and the workstation 112. Also, the communication unit may allow the system 102 to transmit and receive data and signals.

In one example operation, the processor 104 may receive operations data from a set of hierarchically linked controllers associated with the industrial process environment. The set of hierarchically linked controllers may include, in one example, the primary controller 106 and the one or more secondary controllers 108. As discussed above in one example, the primary controller 106 may be the plant-wide controller and may control the working of one or more operations 202 linked with the industrial process environment. Further, the one or more secondary controllers 108 may be, in one example, controllers individually associated with an operation from amongst the one or more operations, as illustrated in FIGS. 2A to 2C, linked with the industrial process environment.

In one example, the set of hierarchically linked controllers may be a singleton set of controllers and the operations data may be received by the processor 104 either from the primary controller 106 or from one of the one or more secondary controllers 108. In another example, the set may include more than one controller. In this example, the operations data may be received from at least two controllers from amongst the primary controller 106 and the one or more secondary controllers 108. For example, the operations data may be received from the primary controller 106 and the secondary controller 108-1 associated with operation 202-1, as illustrated in FIG. 2A.

Further, the set of controllers may be a set of hierarchically linked controllers. For example, the primary controller 106 and the one or more secondary controllers 108 may be hierarchically linked controllers, as discussed with reference to FIGS. 1A to 2C. For instance, the primary controller 106 may control the working of one or more operations of the industrial process environment, whereas each of the one or more secondary controllers 108 may be associated individually with an operation of the industrial process environment. As each of the one or more secondary controllers may be communicably coupled or interlinked with the primary controller 106, and where the primary controller 106 may be the plant-wide controller and the one or more secondary controllers 108 may be associated with individual operations, the primary controller 106 may thus be considered as a higher level controller in the industrial process environment as compared to the one or more secondary controllers 108. Thus, the primary controller 106 may be designated a higher position or importance in the hierarchical linkage or arrangement between the controllers as compared to the one or more secondary controllers 108, that may be designated an immediately lower level, as compared to the primary controller 106.

In one example, the hierarchical linkage between the controllers may be established based on the set of conjoint variables, as discussed with reference to FIGS. 1A to 2C. For instance, the primary controller 106 may be connected to the one or more secondary controllers 108 via the set of conjoint variables. In one example, the one or more secondary controllers 108, say the secondary controller 108-1 associated with the operation 202-1, may store the set of conjoint variables associated with the operation 202-1. The primary controller 106, being the plant-wide controller, may receive the set of conjoint variables from the one or more secondary controller 108 and store the set of conjoint variables associated with each of the operations 202. Thus, the primary controller 106 may have at least the set of conjoint variables available with the one or more secondary controllers 108. For example, the primary controller 106 may have the set of conjoint variables available with the secondary controller 108-1. The set of conjoint variables may thus be a common link between the primary controller 106 and the one or more secondary controllers 108, thereby defining an interlinked and hierarchical relationship between the primary controller 106 and the one or more secondary controllers 108.

Thus, the processor 104, or a data reception unit 508 of the processor, may receive the operations data. In one example, the operations data may provide an insight into one or more parameters related to an operation, say the operation 202-M. The one or more parameters may include, in one example, the set of conjoint variables and the one or more descriptors.

In one example, the set of conjoint variables may include one or more conjoint variables that may be correlated with input and output characteristics of the operation, for example, the operation 202-M. As discussed with reference to FIGS. 1A to 2C, each of the operations 202 may have associated therewith a set of conjoint variables that may be correlated with the input characteristics and output characteristics of the operation. For example, the set of conjoint variables may include a MV indicating a flow rate with which a fluid was supplied for performing an operation and a CV indicating a flow rate with which a processed fluid was outputted due to performance of the operation. Similarly, the set of conjoint variables may include more CVs and MVs indicating different characteristics of input and output of the operation. For example, the set of conjoint variables may include another MV indicating a temperature with which the fluid was supplied for performing the operation and another CV indicating the temperature with which the processed fluid was outputted due to performance of the operation. Thus, the set of conjoint variables may include MVs and CVs indicating input and output characteristics, such as temperature and flow rate, for the operation. Similarly, other examples of CVs and MVs may also be possible that may be included to form a set of the conjoint variables.

Further, since the one or more secondary controllers 108 may be associated with respective operations, say the secondary controller 108-N being associated with the operation 202-M, the one or more secondary controllers 108 may store the set of conjoint variables. The one or more secondary controllers 108, in one example, may share the set of conjoint variables, for the corresponding one or more operations, with the primary controller 106. For example, the secondary controller 108-N may send the set of conjoint variables, determined or monitored based on input and output characteristics of the operation 202-M, to the primary controller 106. Similarly, other secondary controllers may also share the set of conjoint variables with the primary controller 106.

The sharing may be based on different conditions. In one example, the sharing may be upon completion of an operation. In another example, the sharing may be in real-time, i.e., during the performance of the operation or continuance of the performance/execution of the operation. In yet another example, the sharing may be performed by the one or more secondary controllers 108 at regular or pre-defined intervals. The interval may be defined, in one example, by the operator via the workstation 112. Thus, the primary controller 106 may have or store the set of conjoint variables related to the one or more operations 202 linked with the industrial process environment.

In yet another example, it may also be possible that the primary controller 106 may determine the set of conjoint variables based on the input and output characteristics of the one or more operations, instead of receiving the set of conjoint variables from the one or more secondary controllers 108. For example, as the primary controller 106 may be the plant-wide controller, the primary controller 106 may be configured to monitor and/or determine the input and output characteristics of the one or more operations 202 associated with the industrial process environment, and may accordingly determine or derive values of one or more conjoint variables related with the one or more operations.

Further, as discussed above, the primary controller 106 may have the primary limit for the set of conjoint variables and the one or more secondary controllers 108 may have the secondary limit associated with the set of conjoint variables. For example, the primary limit for the flow rate indicated by the conjoint variable may be 100 cubic meters per second (m³/s) and the secondary limit may be 90 m³/s. In one example, the primary limit and the secondary limit may be defined or provided by a user. The user may be, in one example, the operator associated with the industrial process environment who may define, modify, or configure the limits via the workstation 112. Also, as discussed in one example with reference to FIGS. 1A to 2C, some of the conjoint variables in the set of conjoint variables may be critical conjoint variables. For example, amongst the CVs and MVs indicating temperature and flow rate in the above-discussed example, the CVs and MVs indicating flow rate may be the critical conjoint variables.

Thus, the processor 104, or the data reception unit 508, may receive the set of conjoint variables from the set of hierarchically linked controllers. That is, the set of conjoint variables may be received, in one example, from the primary controller 106; or from the primary controller 106 and one or more secondary controllers 108. The set of conjoint variables may include CVs and MVs associated with the one or more operations 202. For example, the set of conjoint variables may include CV_M and MV_M associated with the operation 202-M, as illustrated in FIG. 3.

Further, in one example, the operations data may include the one or more descriptors indicating one or more aspects related to at least one controller in the set of hierarchically linked controllers. As discussed above in one example with reference to FIGS. 1A to 2C, the set of hierarchically linked controllers may generate the one or more descriptors. For example, the one or more secondary controllers 108 may generate descriptors indicating one or more aspects about them. In one example, the descriptors generated by the one or more secondary controllers 108 may be sent to the primary controller 106. Further, in one example, the primary controller 106 may also generate descriptors indicating one or more aspects about it. The one or more aspects may indicate, for example, the operational status indicating whether any of the secondary controllers associated with the operation or the primary controller 106 were unavailable or were not operating in compliance with the primary or secondary limits. The operational status may indicate, for example, PRIMARY CONTROLLER OFF to indicate that the primary controller 106 was unavailable or in a shutdown state. Further, the operational status may indicate, for example, PRIMARY CONTROLLER ON to indicate that the primary controller 106 was available or in a functional state. Similarly, the one or more descriptors may also indicate the operations status of the one or more secondary controllers 108. For example, the one or more descriptors associated with a secondary controller, say the secondary controller 108-N, associated with the operation 202-M may indicate SECONDARY CONTROLLER OFF to indicate that the secondary controller 108-N was unavailable or in a non-functional state.

Further, other examples of indicating the operational status may also be possible. For example, one or more coloured indicators may indicate the operational status of the controllers. For instance, a red coloured indicator may indicate that the one or more secondary controllers 108, say the secondary controller 108-N associated with the operation 202-M, was unavailable; and a green coloured indicator may indicate that the secondary controller 108-N was available. Further, indication of other aspects may also be possible. For example, the operational status may indicate that a controller, whether the primary controller 106 and/or the one or more secondary controllers 108, may be in an underloaded or overloaded state. Similarly, other operational statuses may also be possible and may be indicated by the one or more descriptors.

In one example, the one or more parameters may include the message, as discussed above in one example with reference to FIGS. 1A to 2C. In one example, the message may indicate whether the operation was performed, or is being performed, as per desired requirements. For example, the message may indicate whether the one or more controllers are available and/or operational as desired and/or whether the conjoint variables in the set of conjoint variables comply with the primary and/or secondary limits. In one example, the message may include at least one potential lapse indicator associated with the operation, say the operation 202-M. The potential lapse indicator may be, for example, a textual indication identifying the potential lapse or any error that may have occurred during the operation 202-M. For example, the potential lapse indicator may indicate a description of occurrence of the potential lapse or an error in the performance of the operation 202-M. For example, if any critical conjoint variable, say MV_M, exceeds the primary and/or secondary limits, a potential lapse indicator may be indicated that may represent details of about such incidence.

Similarly, the potential lapse indicator may also be indicated to indicate the operational status of a controller from amongst the set of hiereachically linked controllers. For example, the potential lapse indicator may indicate whether any of the controllers associated with the operation was identified to be unavailable during the operation. Thus, the potential lapse indicator may identify the at least one potential lapse based on the set of conjoint variables and the one or more descriptors.

In one example, the processor 104 may receive at least one of the set of conjoint variables, the one or more descriptors, and the message from the set of hierarchically linked controllers. The received operations data may include at least one of, or any combination of, the set of conjoint variables, the one or more descriptors, and the message. In one example, the operations data may be stored in the datastore 502. The processor 104, in one example, may obtain the operations data from the datastore 502 Further, the processor 104, or a data processing unit 510 of the processor 104, may process the operations data to determine a probable cause of the potential lapse in the operation. Based on at least one of the set of conjoint variables, the one or more descriptors, and the message, the processor 104 may determine the probable cause of the potential lapse. For example, based on the set of conjoint variables, the processor 104 may determine whether any conjoint variable in the set of conjoint variables exceeded the secondary limit. In one example, the conjoint variable may be any critical or important conjoint variable. If the critical conjoint variable, or value thereof, is identified to have exceeded the secondary limit, the critical conjoint variable may be determined as a probable cause of potential lapse. Similarly, the processor 104 may determine whether the conjoint variables or the critical conjoint variables in the set of conjoint variables comply with the required criteria, for example, the primary and/or the secondary limits. Thus, the processor 104 may determine the probable cause based on a determination of whether one or more conjoint variables in the set of conjoint variables comply or do not comply with at least one of the primary limit and the secondary limit.

In another example, the processor 104 may determine the probable cause of the potential lapse based on the one or more descriptors. For example, the processor 104 may determine whether the operational status of at least one of the primary controller 106 and the one or more secondary controllers 108, being indicated by the one or more descriptors, indicate an unfavorable state for the one or more operations 202. In one example, the unfavorable state may be an operational status that may be undesirable for performance of the one or more operations and may lead to the potential lapse. For example, for the operation 202-2, it may be desirable that the primary controller 106 has an operational status indicating ON state for proper functioning of the operation 202-2. Based on the one or more descriptors, the processor 104 may determine whether the operational status of the primary controller 106 is ON. In case the processor 104 determines that the operational status of the primary controller 106 is not ON, the processor 104 may determine that the operational status of the primary controller 106 may be the probable cause. Similarly, the processor 104 may determine whether the operational status of any secondary controller is the probable cause of the potential lapse.

In yet another example, the processor 104 may determine the probable cause of the potential lapse based on the message. In one example, the processor 104 may analyze contents of the message to determine the probable cause. For example, the processor 104 may parse the textual content in the message to determine keywords indicating the probable cause. Any known technique may be used to analyze the message. For example, the processor 104 may utilize tools or libraries to extract keywords indicating the probable cause. In another example, the processor 104 may use a trained machine learning model or a large language model to parse the message and identify keywords that may indicate the probable cause. Other known techniques, or a combination thereof, could also be used to analyze content of the message. For example, if the message indicates that the primary controller 106 is OFF, the processor 104 may analyze the message and determine that the operational status of the primary controller 106 is OFF. As discussed in above example with respect to the operation 202-2, it may be desirable that the primary controller 106 has an operational status indicating ON state for proper functioning of the operation 202-2. Thus, if the processor 104 determines, based on the message, that the primary controller 106 has the operations status of OFF, the processor 104 may determine that the operational status of the primary controller 106 may be the probable cause of the potential lapse.

Thus, based on at least one of the set of conjoint variables, the one or more descriptios, and the message, the processor 104 may determine the probable cause of the potential lapse. Further, in one example, the processor 104 may also identify a highest contributor to the potential lapse. For example, the processore may determine which conjoint variable in the set of conjoint variables has the most significant contribution to the occurrence of the loss. In one example, the conjoint variable that may exceed the most beyond the secondary limit may be determined as the highest contributor, and thus the probable cause of the potential lapse. Similarly, in case of the one or more descriptors and the message, primary controller 106 may be given more weightage and may be considered as the highest contributor from amongst the primary controller 106 and the one or more secondary controllers 108.

Once the processor 104 determines the probable cause, the processor 104, or a parameter-assessment unit 512 of the processor 104, may determine a parameter-assessment workflow from amongst a plurality of parameter-assessment workflows to identify a root cause of the potential lapse. In one example, the datastore 502 may store the plurality of parameter-assessment workflows for different possible probable causes. For example, the datastore 502 may store a parameter-assessment workflow if any conjoint variable, or critical conjoint variable, in the set of conjoint variables is determined to be the probable cause of the potential lapse. The datastore 502 may store a parameter-assessment workflow if any secondary controller 108 from amongst the one or more secondary controllers 108 is determined to be the probable cause of the potential lapse. Similarly, a different parameter-assessment workflow may be available in the datastore 502 if the primary controller 106 is determined to be the probable cause of the potential lapse. Similarly, one or more parameter-assessment workflows may be available in the datastore 502, for example, if the primary limit and/or secondary limit is determined to be the probable cause of the potential lapse.

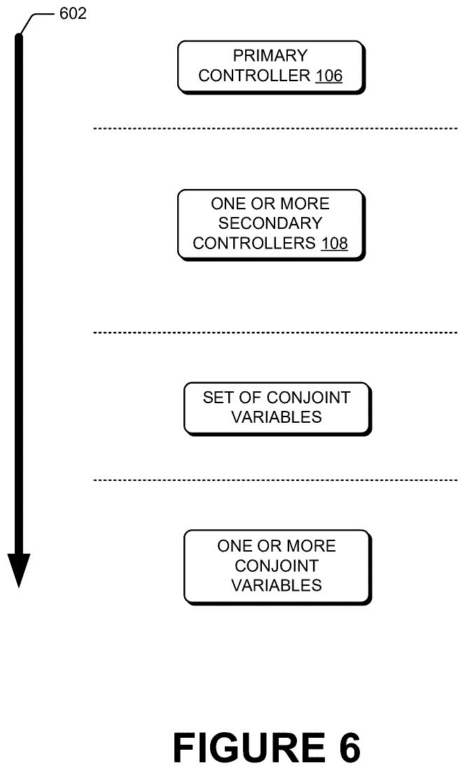

In one example, each of the parameter-assessment workflows may include a set of logically interlinked assessments for identifying the root cause of the potential lapse based on the probable cause. In one example, the set of logically interlinked assessments may include a macro assessment and one or more micro assessments. In one example, the set of logically interlinked assessments may include assessments based on a logic to drill down to deeper assessments in order to identify the root cause. In one example, the drilling down may be based on the hierarchical order. For example, a primary assessment, or the macro assessment may be performed on the primary controller's level. The macro assessment may then be followed by micro assessments that may be performed on the one or more secondary controllers 108. Further micro assessments may then be performed on the set of conjoint variables, followed by another micro assessment to be performed on the one or more conjoint variables in the set of conjoint variables. Such a hierarchical order of assessment is exemplarily issutrated in FIG. 6. FIG. 6 illustrates a block diagram of a hierarchical order of assessment, according to one example implementation of the present subject matter. An arrow 602 illustrates the direction of drilling down, according to one example, from the primary controller's level to the level of set of conjoint variables. Thus, the parameter-assessment workflow may have the set of logically interlinked assessments for identifying a reason or root cause of the potential lapse. For example, the logically interlinked assessments may be checks that may first be performed at the primary controller 106 and then drilled down towards the secondary controllers 108 and, subsequently, towards the conjoint variables.

In one example, the logic for the interlinked assessments may be dependent upon compliance of one or more conditions across different levels in the industrial process environment, for instance, between the primary controller 106, the one or more secondary controllers 108, and the set of conjoint variables. For example, for operation 202-2, it may be important that the primary controller 106 maintains ON operational status. At the highest level, the primary controller 106 may play a crucial role in overseeing the entire operations of the processing facilities. Its operational status, may generally be desired to be “ON” and may often be a prerequisite for the smooth execution of subordinate operations. However, the primary controller's status may not be independent and may be intricately linked to the performance and status of the one or more secondary controllers 108 and the compliance of various conjoint variables with the primary and secondary limits. In one example, the operational status of the primary controller 106 may be dependent on the underlying structure or component. For example, for the primary controller 106 to maintain the ON operational status, it may be critical that the secondary controller 108-2 associated with the operation 202-2 maintains its operational status as ON. In one example, the one or more secondary controllers 108 may form the next tier in the interlinked assessments. The one or more secondary controllers 108 may be responsible for the operations 202 or subsets of the overall processes associated with the processing facility. The operational status of a secondary controller, such as the secondary controller 108-2 for the operation 202-2, may be critical for maintaining the ON status of the primary controller. This may create a bottom-up dependency where the proper functioning of lower-level components directly impacts the operational status of higher-level controllers.

Further, in one example, the operational status of the secondary controller 108-2 may further rely on compliance of the input and output characteristics of the operation 202-2 indicated by the set of conjoint variables with at least one of the primary and secondary limits. The set of conjoint variables may introduce another layer of complexity to the logically interlinked assessments. These conjoint variables may represent key input and output characteristics of specific operations. The compliance of these conjoint variables with predefined limits, such as the primary and/or the secondary limits, may be crucial for maintaining the operational status of the associated secondary controller. If the conjoint variables remain within the specified limits, the secondary controller may maintain its “ON” operational status. However, if a conjoint variable in the set of conjoint variable exceeds any of the limits, say the secondary limit, it may trigger a change in the operational status of the secondary controller to “OFF.”

Such an intricate web of dependencies, or if/else conditions, may allow for a systematic approach to identifying the root cause of the operational lapses in the industrial process environment. By logically interconnecting different levels of checks-from conjoint variable compliance to secondary controller status and up to primary controller operation-the processor 104 may trace the origin of any disruption or malfunction in an operation associated with the industrial process environment. Such a multi-tiered approach may be valuable in complex industrial settings or architectures where components, limits, and operations may be deeply interconnected.

The structure of such interlinked assessments provides a robust framework for maintaining operational integrity and facilitating efficient troubleshooting. It may allow for quick identification of issues at various levels of the process or operation, enabling prompt corrective actions and minimizing downtime. Such checks and balances ensures that the industrial process operates within defined parameters, maintaining both efficiency and safety in the complex industrial environment.

Thus, based on the determined probable cause, the processor 104 may determine a parameter-assessment workflow from amongst a plurality of parameter-assessment workflows. In one example, based on the logic discussed above, the plurality of parameter-assessment workflows may be pre-engineerd or pre-defined and stored in the datastore 502. In one example, the plurality of parameter-assessment workflows may be indexed and stored in the datastore 502. In one example, each of the plurality of parameter-assessment workflows may be stored in form of an executable set of instructions that may be executable by the processor 104. Therefore, based on the probable cause, the processor 104 may identify a corresponding parameter-assessment workflow from amongst the plurality of parameter-assessment workflows to determine the root cause.

Further, each of the plurality of parameter-assessment workflows may include a macro assessment that may be performed based on at least one of the set of conjoint variables having the primary limit associated therewith and the one or more descriptors indicating the operational status of the primary controller 106. Each of the plurality of parameter-assessment workflows may further include one or more macro assessments that may be performed based on at least one of the set of conjoint variables having the secondary limit associated therewith and the one or more descriptors indicating the operational status of the one or more secondary controllers 108.

As one example of the parameter-assessment workflow, the processor 104 may the macro assessment may be performed based on at least one of the set of conjoint variables having the PWO or primary limit associated therewith and the one or more descriptors indicating the operational status of the primary controller. For example, if the probable cause of the potential lapse was determined to be the unavailability of the primary controller 106, the macro assessment may be performed to identify an error that may have probably occurred at the primary controller's level. For example, the processor 104 may perform the macro assessment to determine whether the primary controller 106 was in the OFF operational state. Based on the result of the macro assessment, the processor 104 may determine whether to perform the one or more micro assessments. For example, the processor 104 determines that the operational status was ON, the processor 104 may restrict or not perform the one or more micro assessments. In this case, the processor 104 may, in one example, identify an actionable item having one or more actions recommending to restart the primary controller 106. However, if the processor 104, based on result of the macro assessment, determined that the operational status of the primary controller 106 was OFF, the processor 104 may determine to perform further micro assessments. In one example, the processor 104 may determine the operational status based on at least one of the message and the one or more descriptors received in the operations data.

The processor 104 may then perform a micro assessment or check. The micro assessment may be a deeper check performed at a lower level than the macro assessment. For example, based on the result of the macro assessment, a micro assessment or check may be performed at the secondary controller's level. For instance, if it was determined, at the macro assessment that the primary controller 106 was in the OFF state, the micro assessment may be performed to identify an underlying reason for OFF status of the primary controller 106. In one example, one of the reasons for such an OFF state may be an OFF operational status of the secondary controller associated with the operation, say the secondary controller 108-2 associated with the operation 202-2. For example, since the secondary controller 108-2 may be critical for the primary controller 106 to operate, the primary controller 106 may have turned to OFF status because the secondary controller 108-2 may have turned to OFF status. Thus, in this example, the micro assessment may be performed to determine whether the secondary controller 108-2, being critical for the operation 202-2 and the primary controller 106, was in the OFF state.

Similarly, the processor 104 may perform the one or more micro assessments based on at least one of the set of conjoint variables, such as critical conjoint variables, having the secondary limit associated therewith and the one or more descriptors indicating the operational status of the one or more secondary controllers. For example, subsequent to the micro assessment discussed in the above example, the processor 104 may perform another micro assessment to determine whether any conjoint variable, such as any critical conjoint variable, dropped beyond the secondary limit. As discussed in the above example, the secondary controller 108-2 may be critical for the primary controller 106 to operate and the primary controller 106 may have turned off because the secondary controller 108-2 may have turned off.

Similarly, the critical conjoint variable may be critical either for the functioning of the secondary controller 108-2 or for the operation 202-2. Non-compliance or non-availability of such critical conjoint variables may be one of the reasons that may have led to the turning off of the secondary controller 108-2, thereby being a possible root cause. For example, one of the reasons for such an OFF status of the secondary controller 108-2 may be dependent on whether a critical conjoint variable complies with the secondary limit. It may be possible, for instance, that the secondary controller 108-2 may be in the OFF state because the critical conjoint variable may be beyond the secondary limit. Therefore, in the subsequent micro assessment, the processor 104 may determine whether the critical conjoint variable complied with the secondary limit. Since the conjoint variables may be correlated with the input and output characteristics of the operation 202-2, they may be identified as the root cause for the potential lapse in the operation 202-2. For example, non-compliance of the critical conjoint variable, from amongst the set of conjoint variables, with the secondary limit may be identified as the root cause of the potential lapse. In one example, the processor 104 may also cause rendering of the identified root cause. For example, the processor 104 may generate a root cause indication signal to trigger rendering of the root cause for the operation 202-2. In one example, the root cause may be rendered as a text message on a graphical user interface, such as the graphical user interface 300 (not shown).

Thus, the micro assessment may be drilled down from the secondary controller's level to the level of the conjoint variable to determine the root cause of the potential lapse in the operation 202-2. As each micro assessment may be a lower level check, as compared to its immediately preceding check, for example from the secondary controller's level to the conjoint variable's level, each of the one or more micro assessments may be increasingly proximate to the root cause for the potential lapse as compared to the immediately preceding micro assessment. In one example, the one or more micro assessments may be performed until the root cause is not identified. That is, the processor 104 may further perform alternative checks until the root cause is not identified.

Thus, based on the probable cause, the processor 104 may determine to perform the parameter-assessment workflow to identify the root cause of the potential lapse. Once the root cause is identified, the processor 104 may identify an actionable item, from amongst a plurality of actionable items, indicating an action intended to influence the root cause leading to the potential lapse. In one example, for different root causes, there may be a corresponding pre-defined actionable item stored in the datastore 502. In one example, the operator associated with the industrial process environment may predefine the actionable items for different possible root causes. The actionable items may be, in one example, indexed into the datastore 502 and the processor 104, based on the root case, may identify the corresponding actionable item.

In one example, the actionable item may indicate that the value of the critical conjoint variable may be modified to comply with the secondary limit. As the state or operational status of the secondary controller 108-2 may be dependent upon compliance of the critical conjoint variable with the secondary limit, modification of the critical conjoint variable may result in changing the operational status of the secondary controller 108-2. Further, as the state of the primary controller 106 may be dependent upon the state of the secondary controller 108-2, a change in the state or operational status of the secondary controller 108-2 may cause a change in the state or operational status of the primary controller 106. Thus, the actionable item may indicate that the critical conjoint variable, or value thereof, may be modified, thereby assisting a user, such as the operator, in at least influencing the root cause and thereby influencing or resolving the potential lapse. Similarly, for different root causes, different actionable items could be identified by the processor 104.

Once processor 104 has identified the actionable item, the processor 104, or a signal generation unit 514 of the processor 104, may generate an action recommendation signal to cause rendering of the identified actionable item. By generating the action recommendation signal, the processor 104 may triger rendering of the actionable item. In one example, the actionable item may be rendered as a text message on a graphical user interface, such as the graphical user interface 300 (not shown). The user, or the operator, may be provided with recommended actions to resolve or minimize the potential lapse and thereby the loss being incurred.

Further, in one example, the plurality of parameter-assessment workflows and the plurality of actionable items may be predefined, as discussd above, and stored in the datastore 502. In one example, the plurality of parameter-assessment workflows and the plurality of actionable items may be developed based on historical potential lapses, causes of such potential lapses, and the actions or corrections that were adopted to resolve the potential lapse. Based on the such past experiences, the plurality of parameter-assessment workflows and the plurality of actionable items may be developed and stored in the datastore 502 so that the same may be accessible by the processor 104. Further, though the processor 14 has been illustrated as a separate component or entity than the primary controller 106, according to one example, however, according to another example and as illustrated in FIG. 1D, the processor 104 may also be a part of the primary controller 106 itself.

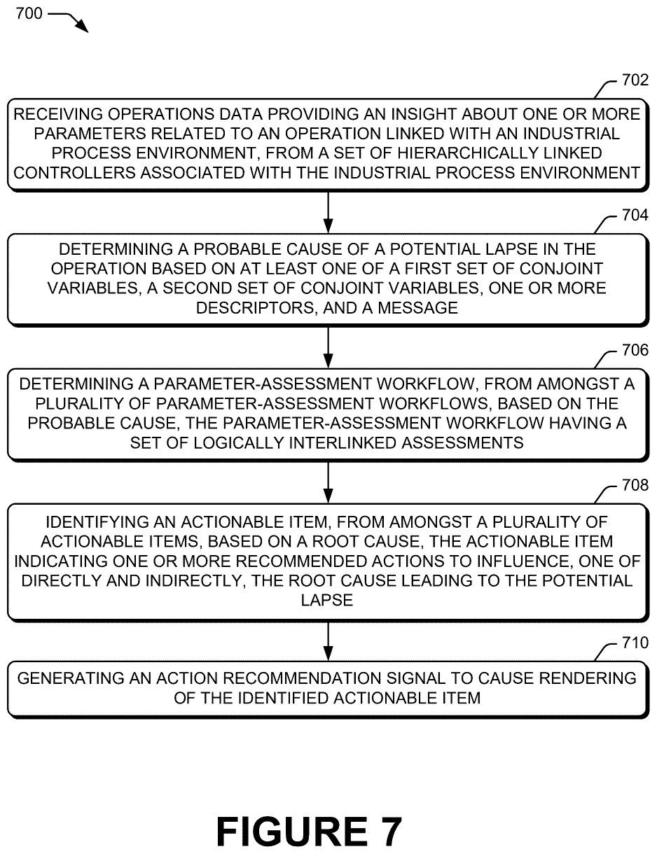

FIG. 7 illustrates a block diagram of an exemplary method 700 for recommending an actionable item, according to one example implementation of the present subject matter. FIG. 7 will be discussed in conjunction with FIGS. 1A to 6. The description of FIGS. 1A to 6 has been incorporated for reference for the sake of brevity.

Further, the order in which the method 700 is described is not intended to be construed as a limitation, and any number of the described method blocks may be combined in any order to implement the method, or an alternative method. Furthermore, method 700 may be implemented by processing resource(s) or computing device(s) through any suitable hardware, non-transitory machine-readable instructions, or combination thereof.

It may also be understood that method 700 may be performed by programmed computing device(s), such as the processor 104, as depicted in FIGS. 1A to 5. Furthermore, the method 700 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the method 700 is described below with reference to the processor 104 and the system 102 as described above; other suitable systems for the execution of these methods may also be utilized. Additionally, the implementation of the method is not limited to such examples.

At block 702, operations data from a set of hierarchically linked controllers associated with an industrial process environment may be received. The operations data may provide an insight about one or more parameters related to an operation linked with the industrial process environment. In one example, the operations data may be received by the processor 104, as discussed above. Further, in one example, the one or more parameters may include a primary indicator, a secondary indicator, one or more descriptors, and a message.

In one example, the primary indicator may indicate values corresponding to each conjoint variable in a first set of conjoint variables associated with a primary controller, such as the primary controller 106. In one example, the primary controller 106 may be the plant-wide controller, as discussed above, and may generate the first set of conjoint variables. The first set of conjoint variables may include one or more conjoint variables. In one example, some of the conjoint variables, from amongst the set of cojoint variables, may be critical conjoint variables. As the primary controller 106 may be the plant-wide controller, the primary controller 106 may monitor the one or more operations associated with the industrial process environment and generate the first set of conjoint variables in correlation with, or based on, input and output characteristics of an operation, say the operation 202-2. The first set of conjoint variables may have the primary limit associated therewith. Further, the primary indicator may indicate a value corresponding to each conjoint variable in the first set of conjoint variables.

Further, in one example, the secondary indicator may indicate values corresponding to each conjoint variable in a second set of conjoint variables associated with one or more secondary controllers, such as the one or more secondary controllers 108. In one example, the one or more secondary controllers 108 may be controllers that may be individually associated with an operation linked with the industrial process environment, as discussed above, and may generate the second set of conjoint variables. The second set of conjoint variables may include one or more conjoint variables. In one example, some of the conjoint variables, from amongst the set of cojoint variables, may be critical conjoint variables. As the one or more secondary controllers 108 may be associated individually with an operation, say the secondary controller 108-2 being associated with the operation 202-2 as discussed and illustrated above, the one or more secondary controllers 108 may monitor their corresponding operations and generate the second set of conjoint variables in correlation with, or based on, input and output characteristics of the corresponding operation, say the operation 202-2. The second set of conjoint variables may have the secondary limit associated therewith. Further, the secondary indicator may indicate a value corresponding to each conjoint variable in the second set of conjoint variables.

Further, in one example, the first set of conjoint variables and the second set of conjoint variables may interlink the primary controller and the one or more secondary controllers, as discussed above. In one example, the first and the second set of conjoint variables may include common conjoint variables because of being associated with the same operation, say the operation 202-2. In another example, the first and the second set of conjoint variables may be the same and may therefore interlink the primary and the one or more secondary controllers. However, in this example, the first set of conjoint variables may have the plant-wide or primary limit and the second set of conjoint variables have the operation-level or the secondary limit associated therewith. Further, the interlinking may also be established in a similar manner as discussed above with reference to FIGS. 1A to 5.

Further, the one or more descriptors may indicate one or more aspects related to at least one of the primary controller 106 and the one or more secondary controller 108, as discussed above with reference to FIGS. 1A to 5. The one or more aspects may include, for example, the operational status of at least one of the primary controller 106 and the one or more secondary controllers 108. Further, the message may include at least one potential lapse indicator associated with the operation. the potential lapse indicator may be identified based on at least one of the first set of conjoint variables, the second set of conjoint variables, and the one or more descriptors. The message may be similar and may include similar features as discussed above with reference to FIGS. 1A to 5.

At block 704, a probable cause of a potential lapse in the operation may be determined based on at least one of the first set of conjoint variables, the second set of conjoint variables, the one or more descriptors, and the message, as discussed above with reference to FIGS. 1A to 5. For example, based on the first or second set of conjoint variables, the processor 104 may determine whether any conjoint variable in the first or second set of conjoint variables exceeded the limits corresponding to the first and the second set of conjoint variables. If a conjoint variable, say from the first set of conjoint variables, is identified to have exceeded the primary limit, the conjoint variable in the first set of conjoint variables may be determined as a probable cause of potential lapse in the operation. Similarly, the probable cause of potential lapse could also be determined based on the message and/or the one or more descriptors, as discussed above with reference to FIGS. 1A to 5.

At block 706, a parameter-assessment workflow, from amongst a plurality of parameter-assessment workflow, may be determined. The determination may be based on the determined probable cause. In one example, the parameter-assessment workflow may include a set of logically interlinked assessments that may include a macro assessment and one or more micro assessments. In one example, the macro assessment may be performed based on at least one of the first set of conjoint variables having the primary limit associated therewith and the one or more descriptors indicating the operational status of the primary controller 106, as discussed above with reference to FIG. 5. Further, the one or more micro assessments may be performed based on at least one of the second set of conjoint variables having the secondary limit associated therewith and the one or more descriptors indicating the operational status of the one or more secondary controllers 108, as discussed above with reference to FIG. 5.

In one example, the one or more micro assessments may be performed based on a result of at least one of the macro assessment and an immediately preceding micro assessment. Further, each micro assessment may be increasingly proximate to a root cause for the potential lapse as compared to the immediately preceding micro assessment. Further, the one or more micro assessments may be performed until the root cause is identified, as discussed above with reference to FIG. 5.

At block 708, an actionable item, from amongst a plurality of actionable items, may be identified based on the root cause. In one example, the actionable item may indicate a recommended action to influence the root cause leading to the potential lapse, as discussed above with reference to FIG. 5.

At block 710, an action recommendation signal may be generated to cause rendering of the identified actionable item. Generation of the action recommendation signal may cause rendering of the actionable item, or at least the recommended action, on a graphical user interface, such as the graphical user interface 300.

Further, rendering of one or more graphical user interfaces may also be caused to indicate at least one of the primary indicator, the secondary indicator, the one or more descriptors, the message, the root cause, and the identified actionable item. In one example, at least one of the primary indicator, the secondary indicator, the one or more descriptors, the message, the root cause, and the identified actionable item may be rendered in textual format. A user may thus be provided with multiple insight about the operation along with the action that may be opted to influence or minimize the potential lapse in the operation associated with the industrial process environment.

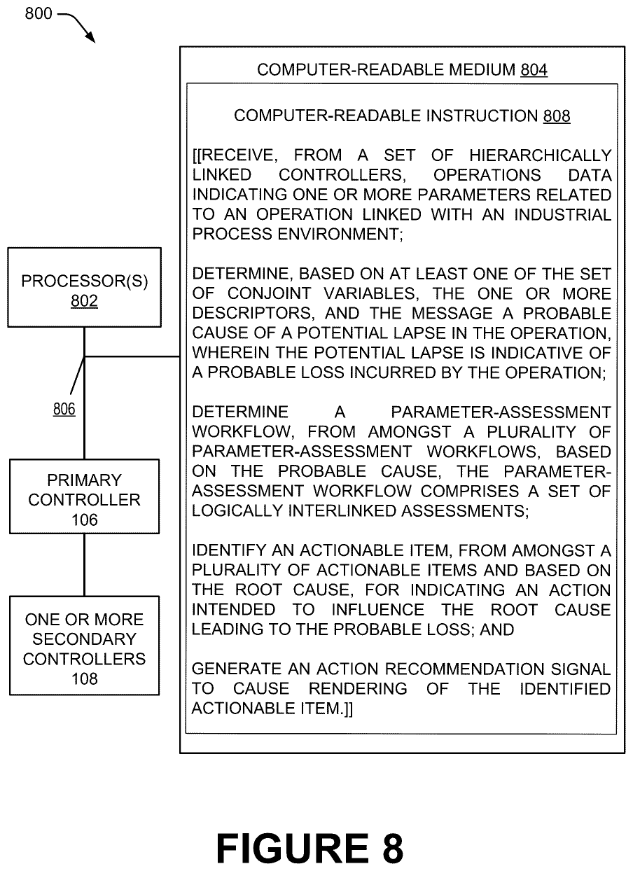

FIG. 8 illustrates a non-transitory computer-readable recommending an actionable item, in accordance with an example of the present subject matter. FIG. 8 will be discussed with reference to FIGS. 1A to 6. The description of FIGS. 1A to 6 has been incorporated for reference for the sake of brevity.

In an example, the computing environment 800 includes a processor 802 communicatively coupled to a non-transitory computer-readable medium 804 through communication link 806. In one example, the processor 802 may include one or more processing resources for fetching and executing computer-readable instructions from the non-transitory computer-readable medium 804. The processor 802 and the non-transitory computer-readable medium 804 may be implemented, for example, in the system 102.

The non-transitory computer-readable medium 804 may be, for example, an internal memory device or an external memory. In an example implementation, the communication link 806 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer-readable medium 804 includes a set of computer-readable instructions 808 which may be accessed by the processor 802 through the communication link 806. The processor 802 and the non-transitory computer-readable medium 804 may also be communicatively coupled to the primary controller 106 and the one or more secondary resources 108 over the communication link 806.

Referring to FIG. 9, in one example, the non-transitory computer-readable medium 804 includes computer-readable instructions 808 that may cause the processor 802 to receive operations data from a set of hierarchically linked controllers associated with an industrial process environment. The operations data may provide an insight about one or more parameters related to an operation linked with the industrial process environment. The one or more parameters may include, in one example, at least one of the set of conjoint variables, the one or more descriptors, and the message. The set of conjoint variables, in one example, may be correlated with input characteristics and output characteristics of the operation. The set of conjoint variables may also interlink two or more controllers from amongst the set of hierarchically linked controllers. For example, the set of conjoint variables may be common between the primary controller 106 and the one or more secondary controllers 108.

Further, the set of hierarchically linked controllers may include the primary controller 106 having the primary limit associated with the set of conjoint variables. In one example, the primary limit may be the plant-wide limit for the set of conjoint variables. The set of hierarchically linked controllers may also include the one or more secondary controllers 108 having the secondary limit associated with the set of conjoint variables. In one example, the secondary limit may be the operation-level limit for the set of conjoint variables.

Further, the one or more descriptors may indicate one or more aspects related to at least one controller in the set of hierarchically linked controllers. The one or more aspects may include, for example, the operational status of the primary controller 106 and the one or more secondary controllers 108, as discussed above with reference to FIGS. 1A to 5. Further, the message may include at least one potential lapse indicator associated with the operation. The potential lapse indicator may be identified based on at least one of the set of conjoint variables and the one or more descriptors. The message may be similar and may include similar features as discussed above with reference to FIGS. 1A to 5.

Further, the non-transitory computer-readable medium 804 includes computer-readable instructions 808 that may cause the processor 802 to determine a probable cause of a potential lapse in the operation based on at least one of the set of conjoint variables, the message, and the one or more descriptors. For example, if one or more conjoint variables in the set of conjoint variables does not comply with at least one of the primary limit and the secondary limit, the one or more conjoint variables may be determined as the probable cause of the potential lapse. In another example, if the operational status of at least one of the primary controller 106 and the one or more secondary controllers 108 is determined to be indicating an unfavorable state for the operation, the controller having the unfavorable state may be determined as the probable cause of the potential lapse, as discussed above with reference to FIG. 5.

Further, the non-transitory computer-readable medium 804 includes computer-readable instructions 808 that may cause the processor 802 to determine a parameter-assessment workflow, from amongst a plurality of parameter-assessment workflows. The determination may be based on the determined probable cause. In one example, the parameter-assessment workflow may include a set of logically interlinked assessments that may include a macro assessment and one or more micro assessments. In one example, the processor 802 may perform the macro assessment based on at least one of the set of conjoint variables having the primary limit associated therewith and the one or more descriptors indicating the operational status of the primary controller 106.

Further, the processor 802 may perform the one or more micro assessments based on at least one of the set of conjoint variables having the secondary limit associated therewith and the one or more descriptors indicating the operational status of the one or more secondary controllers 108. The processor 802 may perform the one or more micro assessments based on a result of at least one of the macro assessment and an immediately preceding micro assessment. Further, each micro assessment may be increasingly proximate to a root cause for the potential lapse as compared to the immediately preceding micro assessment. Further, the processor 802 may perform the one or more micro assessments until the root cause is identified.

Further, the non-transitory computer-readable medium 804 includes computer-readable instructions 808 that may cause the processor 802 to identify an actionable item, from amongst a plurality of actionable items, based on the root cause. In one example, the actionable item may be identified for indicating an action intended to at least influence the root cause leading to the potential lapse, as discussed above with reference to FIG. 5.

Further, the non-transitory computer-readable medium 804 includes computer-readable instructions 808 that may cause the processor 802 to generate an action recommendation signal to cause rendering of the identified actionable item. By generating the action recommendation signal, the processor 802 may cause or trigger rendering of the identified actionable item. In one example, the non-transitory computer-readable medium 804 includes computer-readable instructions 808 that may cause the processor 802 to cause rendering of one or more graphical user interfaces to indicate at least one of the message, conjoint variables in the set of conjoint variables, the one or more descriptors, the root cause, and the identified actionable item.

Thus, the present subject matter provides techniques that may assist a user in identifying a root cause leading to the potential lapse and recommending a suitable action to at least influence the root cause and, thereby attempt to minimize the potential lapse. Therefore, the user may be able to correctly and quickly take required actions for reducing or minimizing the lapse or loss being incurred by the operation.

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A system comprising:
a processor to:
receive, from a set of hierarchically linked controllers associated with an industrial process environment, operations data providing an insight about one or more parameters related to an operation linked with the industrial process environment, wherein the one or more parameters comprises at least one of:
a set of conjoint variables correlated with input characteristics and output characteristics of the operation and interlinking two or more controllers from amongst the set of hierarchically linked controllers, the set of hierarchically linked controllers comprising:
a primary controller having a primary limit associated with the set of conjoint variables, the primary limit being a plant-wide limit for the set of conjoint variables; and
one or more secondary controllers having a secondary limit associated with the set of conjoint variables, the secondary limit being an operation-level limit for the set of conjoint variables; and
one or more descriptors indicating one or more aspects related to at least one controller in the set of hierarchically linked controllers, the one or more aspects comprising an operational status of the primary controller and the one or more secondary controllers;
determine, based on at least one of the set of conjoint variables and the one or more descriptors, a probable cause of a potential lapse in the operation;
determine a parameter-assessment workflow, from amongst a plurality of parameter-assessment workflows, based on the probable cause, the parameter-assessment workflow comprises a set of logically interlinked assessments, the set of logically interlinked assessments comprising:
a macro assessment performed based on at least one of the set of conjoint variables having the primary limit associated therewith and the one or more descriptors indicating the operational status of the primary controller; and
one or more micro assessments, each being performed based on at least one of the set of conjoint variables having the secondary limit associated therewith and the one or more descriptors indicating the operational status of the one or more secondary controllers,
wherein the one or more micro assessments are to be performed based on a result of at least one of the macro assessment and an immediately preceding micro assessment, each of the one or more micro assessments being increasingly proximate to a root cause for the potential lapse as compared to the immediately preceding micro assessment;
identify an actionable item, from amongst a plurality of actionable items and based on the root cause, for indicating an action intended to influence the root cause leading to the potential lapse; and
generate an action recommendation signal to cause rendering of the identified actionable item.

2. The system of claim 1, wherein the one or more micro assessments are to be performed until the root cause is identified.

3. The system of claim 1, wherein the processor is to restrict performance of the one or more micro assessments if the root cause is identified based on the result of the macro assessment.

4. The system of claim 1, wherein the processor is to cause rendering of one or more graphical user interfaces to indicate at least one of a message, conjoint variables in the set of conjoint variables, the one or more descriptors, the root cause, and the identified actionable item.

5. The system of claim 4, wherein the one or more parameters further comprises the message having at least one potential lapse indicator associated with the operation, wherein the at least one potential lapse indicator is identified based on the set of conjoint variables and the one or more descriptors.

6. The system of claim 5, wherein the processor is to determine the probable cause of the potential lapse based on at least one of the set of conjoint variables, the one or more descriptors, and the message.

7. The system of claim 1, wherein the one or more secondary controllers are linked with the primary controller using the set of conjoint variables, wherein the set of conjoint variables include one or more critical conjoint variables.

8. The system of claim 1, wherein the potential lapse in the operation is related to a lost opportunity indicating a probable loss incurred by the operation linked with the industrial process environment.

9. The system of claim 1, wherein the primary controller controls working of one or more operations linked with the industrial process environment, and wherein each of the one or more secondary controllers is individually associated with an operation from amongst the one or more operations linked with the industrial process environment.

10. The system of claim 1, wherein the set of conjoint variables comprises:
one or more control variables (CVs) correlated with the output characteristics of the operation; and
one or more manipulative variables (MVs) correlated with the input of the operation, wherein the MV is an adjustable variable, and wherein adjustment of the MV is to cause modification in the CV.

11. The system of claim 1, wherein the processor is to determine the probable cause based on a determination of at least one of:
non-compliance of one or more conjoint variables in the set of conjoint variables with at least one of the primary limit and the secondary limit; and
the operational status of at least one of the primary controller and the one or more secondary controllers indicating an unfavorable state for the operation, the unfavorable state being indicated by the one or more descriptors.

12. A method comprising:
receiving operations data providing an insight about one or more parameters related to an operation linked with an industrial process environment, from a set of hierarchically linked controllers associated with the industrial process environment, the one or more parameters comprising at least one of:
a primary indicator indicating values corresponding to each conjoint variable in a first set of conjoint variables associated with a primary controller, wherein the first set of conjoint variables have a primary limit associated therewith;
a secondary indicator indicating values corresponding to each conjoint variable in a second set of conjoint variables associated with one or more secondary controllers, wherein the second set of conjoint variables have a secondary limit associated therewith; and
one or more descriptors indicating one or more aspects related to at least one of the primary controller and the one or more secondary controllers, the one or more aspects comprising an operational status of at least one of the primary controller and the one or more secondary controllers; and
a message comprising at least one potential lapse indicator associated with the operation, wherein the at least one potential lapse indicator is identified based on the first set of conjoint variables, the second set of conjoint variables, and the one or more descriptors;
determining a probable cause of a potential lapse in the operation based on at least one of the first set of conjoint variables, the second set of conjoint variables, the one or more descriptors, and the message;
determining a parameter-assessment workflow, from amongst a plurality of parameter-assessment workflows, based on the probable cause, the parameter-assessment workflow having a set of logically interlinked assessments comprising:
a macro assessment performed based on at least one of the first set of conjoint variables having the primary limit associated therewith and the one or more descriptors indicating the operational status of the primary controller; and
one or more micro assessments, each being performed based on at least one of the second set of conjoint variables having the secondary limit associated therewith and the one or more descriptors indicating the operational status of the one or more secondary controllers,
wherein the one or more micro assessments are to be performed based on a result of at least one of the macro assessment and an immediately preceding micro assessment, wherein each of the one or more micro assessments is increasingly proximate to a root cause for the potential lapse as compared to the immediately preceding micro assessment, and wherein the one or more micro assessments are to be performed until the root cause is identified;
identifying an actionable item, from amongst a plurality of actionable items, based on the root cause, the actionable item indicating one or more recommended actions to influence, one of directly and indirectly, the root cause leading to the potential lapse; and
generating an action recommendation signal to cause rendering of the identified actionable item.

13. The method of claim 12, wherein the first set of conjoint variables and the second set of conjoint variables interlink the primary controller with the one or more secondary controllers.

14. The method of claim 12, the method further comprising causing rendering of one or more graphical user interfaces to indicate at least one of the primary indicator, the secondary indicator, the one or more descriptors, the message, the root cause, and the identified actionable item.

15. The method of claim 12, wherein the primary limit is a plant-wide limit for the first set of conjoint variables and the secondary limit is an operation-level limit for the second set of conjoint variables.

16. The method of claim 15, wherein the first set of conjoint variables and the second set of conjoint variables include similar one or more conjoint variables, wherein the one or more conjoint variables in the first set of conjoint variables have the primary limit associated therewith and the one or more conjoint variables in the second set of conjoint variables have the secondary limit associated therewith.

17. The method of claim 12, wherein each of the first set of conjoint variables and the second set of conjoint variables comprises one or more conjoint variables correlated with input characteristics and output characteristics of the operation.

18. A non-transitory computer-readable medium comprising instructions, the instructions being executable by a processing resource to:
receive, from a set of hierarchically linked controllers, operations data indicating one or more parameters related to an operation linked with an industrial process environment, wherein the one or more parameters comprises at least one of:
a set of conjoint variables correlated with input characteristics and output characteristics of the operation and interlinking two or more controllers from amongst the set of hierarchically linked controllers, the set of hierarchically linked controllers comprising:
a primary controller having a primary limit associated with the set of conjoint variables, the primary limit being a plant-wide limit for the set of conjoint variables; and
one or more secondary controllers having a secondary limit associated with the set of conjoint variables, the secondary limit being an operation-level limit for the set of conjoint variables;
one or more descriptors indicating one or more aspects related to at least one controller in the set of hierarchically linked controllers, the one or more aspects comprising an operational status of the primary controller and the one or more secondary controllers; and
a message comprising at least one potential lapse indicator associated with the operation, wherein the at least one potential lapse indicator is identified based on the set of conjoint variables and the one or more descriptors;
determine, based on at least one of the set of conjoint variables, the one or more descriptors, and the message a probable cause of a potential lapse in the operation, wherein the potential lapse is indicative of a probable loss incurred by the operation;
determine a parameter-assessment workflow, from amongst a plurality of parameter-assessment workflows, based on the probable cause, the parameter-assessment workflow comprises a set of logically interlinked assessments, the set of logically interlinked assessments comprising:
a macro assessment performed based on at least one of the set of conjoint variables having the primary limit associated therewith and the one or more descriptors indicating the operational status of the primary controller; and
one or more micro assessments, each being performed based on at least one of the set of conjoint variables having the secondary limit associated therewith and the one or more descriptors indicating the operational status of the one or more secondary controllers,
wherein the one or more micro assessments are to be performed based on a result of at least one of the macro assessment and an immediately preceding micro assessment, each of the one or more micro assessments being increasingly proximate to a root cause for the potential lapse as compared to the immediately preceding micro assessment, and wherein the one or more micro assessments are to be performed until the root cause is identified;
identify an actionable item, from amongst a plurality of actionable items and based on the root cause, for indicating an action intended to influence the root cause leading to the probable loss; and
generate an action recommendation signal to cause rendering of the identified actionable item.

19. The non-transitory computer-readable medium of claim 18, the instructions being executable by the processing resource to determine at least one of:
non-compliance of one or more conjoint variables in the set of conjoint variables with at least one of the primary limit and the secondary limit; and
the operational status of at least one of the primary controller and the one or more secondary controllers to be indicating an unfavorable state for the operation.

20. The non-transitory computer-readable medium of claim 18, the instructions being executable by the processing resource to cause rendering of one or more graphical user interfaces to indicate at least one of the message, conjoint variables in the set of conjoint variables, the one or more descriptors, the root cause, and the identified actionable item.
